(19) United States
(12) Patent Application Publication
(10) Pub. No.: US 2019/0087205 A1
(43) Pub. Date: Mar. 21, 2019

(54) VARYING MODALITY OF USER EXPERIENCES WITH A MOBILE DEVICE BASED ON CONTEXT

(71) Applicant: Microsoft Technology Licensing, LLC, Redmond, WA (US)

(72) Inventor: Shai Guday, Redmond, WA (US)

(21) Appl. No.: 15/707,206

(22) Filed: Sep. 18, 2017

(51) Int. Cl. G06F 9/44; G06T 11/60; G06F 3/0481

(52) U.S. Cl. CPC G06F 9/4446; G06F 3/04817; G06T 11/60

(57) ABSTRACT

A digital assistant supported on a local device and/or a remote digital assistant service is configured to track contextual data associated with a user and dynamically load or pre-load various modalities to provide increased ease of use for the user. Various modalities can include adjustments to the graphical icons displayed on the user's device, such as the type, shape, color, size, orientation, and position of the icons. The digital assistant may track context data such as the user's location, upcoming schedule in the user's calendar, user interactions with the digital assistant, and the like to determine the best modality for the user. In one exemplary embodiment, the digital assistant may pre-load a modality with travel applications when the digital assistant learns that the user has scheduled a flight. The digital assistant may render the pre-loaded modality when the user arrives at the airport.

### BACKGROUND

Mobile computing devices such as smartphones and tablets are typically configured with graphical icons on their graphical user interfaces (GUI), which can provide a variety of useful and convenient features for computing device users.

### SUMMARY

A digital assistant or other suitable functionality supported on a computing device such as a smartphone, tablet, personal computer (PC), media player, wearable computing device including smartwatches and head-mounted display (HIVID) devices, and the like is configured to automatically adjust a modality of a display responsively to context and/or interactions with a device user. A modality may be a configuration of graphical elements such as icons as well as a configuration of the overall graphical user interface (GUI) supported on a display on a user's device. Factors that may affect a modality may include one or more of type, size, color, position, appearance, orientation, and animation of graphical elements. The digital assistant may analyze applicable context associated with a user and/or one or more devices to determine a modality that enhances the coherence and utility of a given user experience. Various adjustments made to icon types and characteristics (e.g., size, shape, etc.) can further increase the user's ease in operating a device. In addition, disfavored modalities can be expeditiously transitioned out of user experiences based on crowd-sourced data from a group of unique users. Varying the modality to fit the applicable context can further enable limited resources such as a battery power and network bandwidth to be conserved to thereby improve device operation.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure. It will be appreciated that the above-described subject matter may be implemented as a computer-controlled apparatus, a computer process, a computing system, or as an article of manufacture such as one or more computer-readable storage media. These and various other features will be apparent from a reading of the following Detailed Description and a review of the associated drawings.

### DESCRIPTION OF THE DRAWINGS

FIG. 1 shows illustrative configurations of graphical user interface (GUI) modalities which can be implemented on mobile devices;

FIG. 2 shows an illustrative system architecture in which a GUI layer in addition to other system layers interoperate with each other;

FIG. 3 shows an illustrative remote and a local digital assistant with respective modality modules affecting the modality on a display of a user device;

FIG. 4A shows an illustrative taxonomy of functions performed by the digital assistant;

FIG. 4B shows a taxonomy of characteristics for a modality that can be adjusted by the digital assistant;

FIG. 5 shows various modalities created by the digital assistant based on context data;

FIG. 6 shows illustrative categories that icons may be placed in based on the icon's application function;

FIG. 7 shows illustrative context data that may be utilized by the digital assistant;

FIG. 8 shows an illustrative process in which the digital assistant may perform to determine a GUI modality;

FIGS. 9 and 10 show an illustrative user interaction with a digital assistant and the resultant modality;

FIGS. 11 and 12 show an illustrative scenario and the digital assistant's resultant determination for the modality;

FIGS. 13 and 14 show an illustrative scenario and the digital assistant's resultant determination for the modality;

FIGS. 15-18 show an illustrative user interaction with the digital assistant and the resultant modalities;

FIG. 19 shows an illustrative process for FIGS. 15-18 in which the digital assistant, based on the context data, loads a classic modality, pre-loads a first modality, and pre-loads a second modality;

FIG. 20 shows an illustrative environment in which a plurality of users transmit feedback to a digital assistant service;

FIG. 21 shows an illustrative example of user feedback;

FIG. 22 shows an illustrative environment in which the modality service updates the adjusted modality and a corresponding modality in response to the user feedback;

FIG. 23 shows an illustrative environment in which the digital assistant service transmits corresponding adjusted modalities back to the user's device.

FIG. 24 shows an illustrative environment in which the modality service forwards an adjusted modality to non-participating users when corresponding feedback is received from a pre-set threshold of users;

FIG. 25 shows an illustrative process of the environment in FIG. 24;

FIGS. 26-28 show illustrative processes performed by a digital assistant or digital assistant service;

FIG. 29 is a block diagram of an illustrative computer system that may be used in part to implement the varying modality of user experiences with mobile devices based on context;

FIG. 30 shows a block diagram of an illustrative device that may be used in part to implement the present varying modality of user experiences with mobile devices based on context.

FIG. 31 is a block diagram of an illustrative device such as a mobile phone or smartphone;

FIG. 32 is a block diagram of an illustrative multimedia system or game system;

FIG. 33 is a pictorial view of an illustrative example of a virtual reality or mixed reality head mounted display (HMD) device; and

FIG. 34 shows a block diagram of an illustrative example of a virtual reality or mixed reality HMD device.

Like reference numerals indicate like elements in the drawings. Elements are not drawn to scale unless otherwise indicated.

### DETAILED DESCRIPTION

The modality of user experiences with mobile devices can be varied to enhance ease of use and improve the device performance in a variety of different scenarios. In one illustrative scenario, the digital assistant may observe, with notice to the user and user consent, calendar and location data associated with the user. Based on the observations, the digital assistant determines that the user has a flight scheduled at the airport and the user is currently driving toward the airport. The digital assistant may automatically pre-load a new modality that shows various travel icons available to the user, such as applications related to travel and the user's ticket. The pre-loaded modality may be exposed on the device when the user arrives at the airport. As an alternative, the digital assistant may immediately load and display the new modality upon arrival.

The new modality may be a completely new GUI experience on the user's display in some cases. For example, the new modality may divide the device's display screen into one or more regions, such as an active region and a classic region. The digital assistant may position the new modality in an active region of the display and position unrelated icons in the classic region. The classic region of the display can depict a generic configuration of the GUI (e.g., the typical GUI selected by the user). Since the active region includes a modality based on the context data, the active region may alternatively be designated as a context-based region. When the digital assistant creates and loads the new modality into the active (or context-based) region, the active region may be positioned in front of the classic region or otherwise be given more prominence than the classic region.

Continuing with this illustrative scenario, prior to the airport arrival, the user may request from the digital assistant information regarding services such as food and concessions that are available at the airport. In response, the digital assistant may provide the user with responsive service information, through voice, sounds, graphics, or text. Based on the user interaction, the digital assistant may supplement and adjust the pre-loaded modality that originally only included travel and ticket applications. For example, the digital assistant may adjust the pre-loaded modality to include a food and dining application and links to one or more websites for available restaurants.

The digital assistant may also adjust the presentation of the modality based on the context data. For example, if available context indicates low temperatures from cold weather, the digital assistant may logically infer that the user may be wearing gloves. The digital assistant may increase the sizes of the displayed icons to accommodate the increased surface area of the gloves and make it easier for the user to make selections. Such changes to the GUI may be considered a new modality since each modality is based on different context.

Subsequent to or contemporaneously with providing the user with the new modality, the digital assistant may continue to pre-load various modalities throughout the day. By intelligently loading and pre-loading useful icons in accommodating configurations based on a given scenario, users are provided with greater ease of use and convenience when using their mobile device. Users can also typically spend less effort navigating through the GUI on their device to find the icons of interest which can reduce device resource utilization to thereby make device operations more efficient.

In an illustrative embodiment, the user may provide feedback to the digital assistant regarding a modality. The digital assistant can then analyze and apply the feedback to other applicable modalities to further tailor the modality to particular context and use scenarios. Changes or adjustments in configuration may include, for example, changes in type of icons, color, position, size, shape, etc. Thus, if a user chooses to adjust a particular modality, such as shrink or expand the size of a given icon, then the digital assistant may identify other similar or applicable modalities (created previously or in the future), and apply that adjustment of size to the other modalities.

In another illustrative embodiment, a digital assistant service supported on a remote server may interoperate with a plurality of devices associated with a group or universe of unique users. Each of the unique users may adjust a given modality characteristic, such as icon size, which is transmitted to the digital assistant service. When the service identifies that a threshold number of users have made corresponding adjustments to the GUI or elements therein, the service may store an update to that modality to reflect such adjustment. In addition, the service may implement that adjustment across other similar or applicable modalities that it supports. Even further, the service can implement the adjustment to new users or existing users who have not provided feedback. Such crowd-sourced data from the universe of other users can thus be used to provide finely-tuned and relevant user experiences across a range of different users.

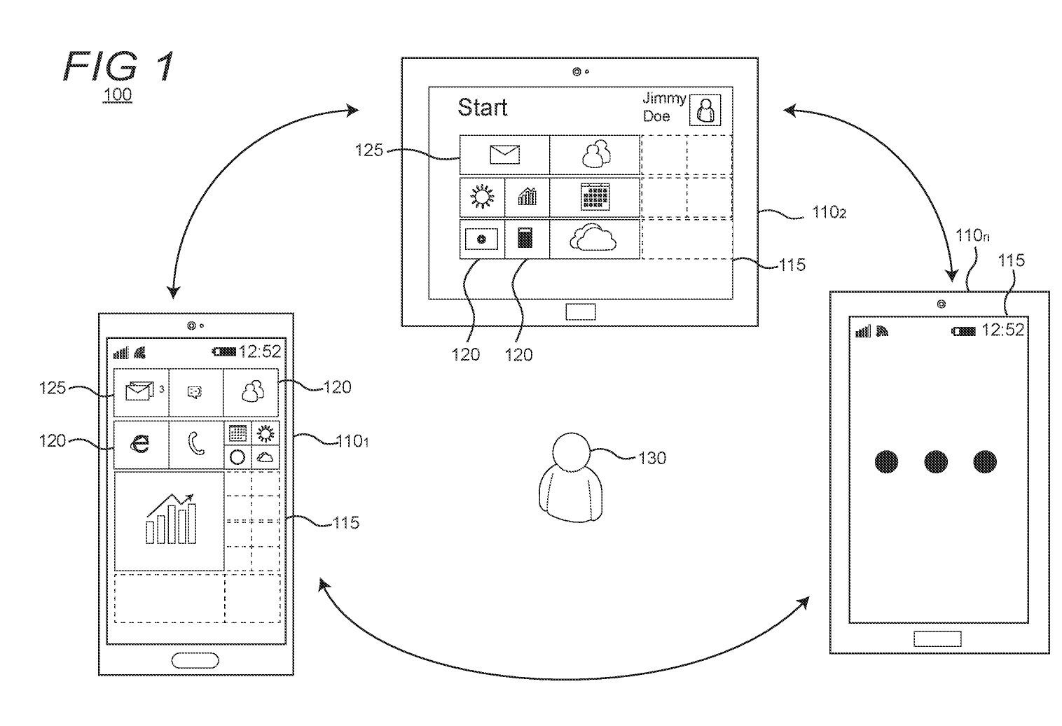

Turning now to the drawings, FIG. 1 shows illustrative configurations 100 for GUIs on mobile devices 110. As depicted in FIG. 1, mobile devices may be of various types, including smartphones and tablets. Although not shown, other types of devices including wearable devices such as HMD displays and wearable smartwatches, wrist bands, laptop computers, game devices, media players, and the like may also be utilized to support varying modalities. The devices may support network connectivity and data-consuming applications such as internet browsing and multimedia (e.g., music, video, etc.) consumption in addition to various other features and applications. In addition, these devices may be employed by a user 130 to make and receive voice and/or video calls, share multimedia, engage in messaging (e.g., texting) and e-mail communications, use applications, and access services that employ data, browse the World Wide Web, and the like.

For example, applications represented by graphical elements such as icons 120 across the displays 115 of devices 110 in FIG. 1 include mail, message, weather, calendar, phone, cloud accessibility, finance, video, and a digital assistant. In this example, the smartphone and tablet devices support different illustrative modalities—the smartphone GUI uses varying border sizes around each respective icon which are different from the border sizes around similar icons on the tablet computer. For example, the mail applications 125 on both devices are graphically distinct. The smartphone includes a numeric count of unread e-mails along with two envelopes. In contrast, the tablet computer depicts a larger border with a single envelope to represent the mail application 125. The third smartphone shows that additional modalities are available to these devices.

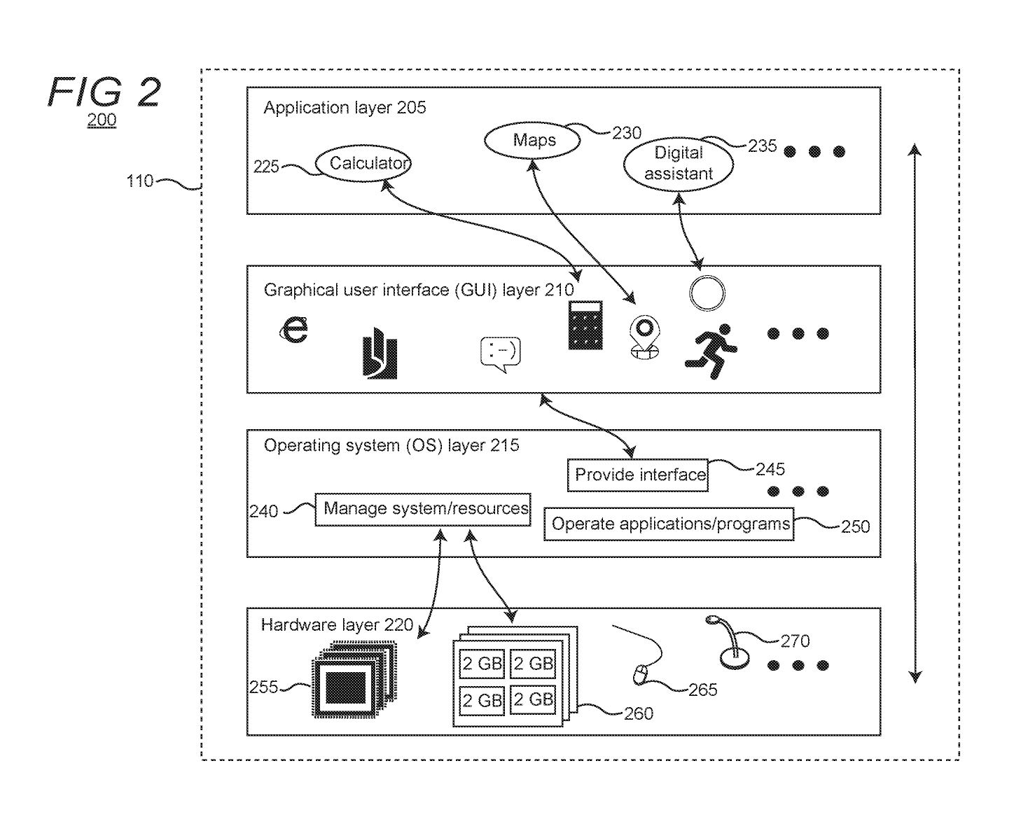

FIG. 2 shows an illustrative system architecture 200 in which the various layers of a device 110 interoperate with each other. A mobile computing device, in simplified form, may include an application layer 205, GUI layer 210, operating system (OS) layer 215, and a hardware layer 220. The application layer provides various services to a user. As depicted in FIG. 2, applications can include a calculator 225, maps 230, or digital assistant 235, and may also include word processing applications, Internet browsing, etc. (not shown). The applications may coordinate with a GUI, as depicted by the GUI layer. The user may select an icon in the GUI to load and launch a particular application, for example, by touch to a touchscreen display, using voice command, or using a pointing device.

The applications and GUI interfaces may interoperate with the OS layer 215. The OS layer can manage the system and resources 240, provide the GUI 245 for the user, and control operation of applications 250. Thus, if a user selects an application, the OS layer can execute the functions and processes associated with the selected application, such as enabling the calculator, maps, or digital assistant to execute on the device. In addition, the OS layer may interoperate with the hardware layer 220 and manage the various hardware components. For example, the hardware layer can include abstractions of one or more processors 255 such as central processing units (CPU) and graphic processing units (GPU), memory 260 (e.g., hard-disk drive, flash memory, etc.), and also user input/output devices such as a pointing device (e.g., mouse) 265, or microphone 270. Other input/output devices (not shown) may include a keyboard, touch screen display, and speakers.

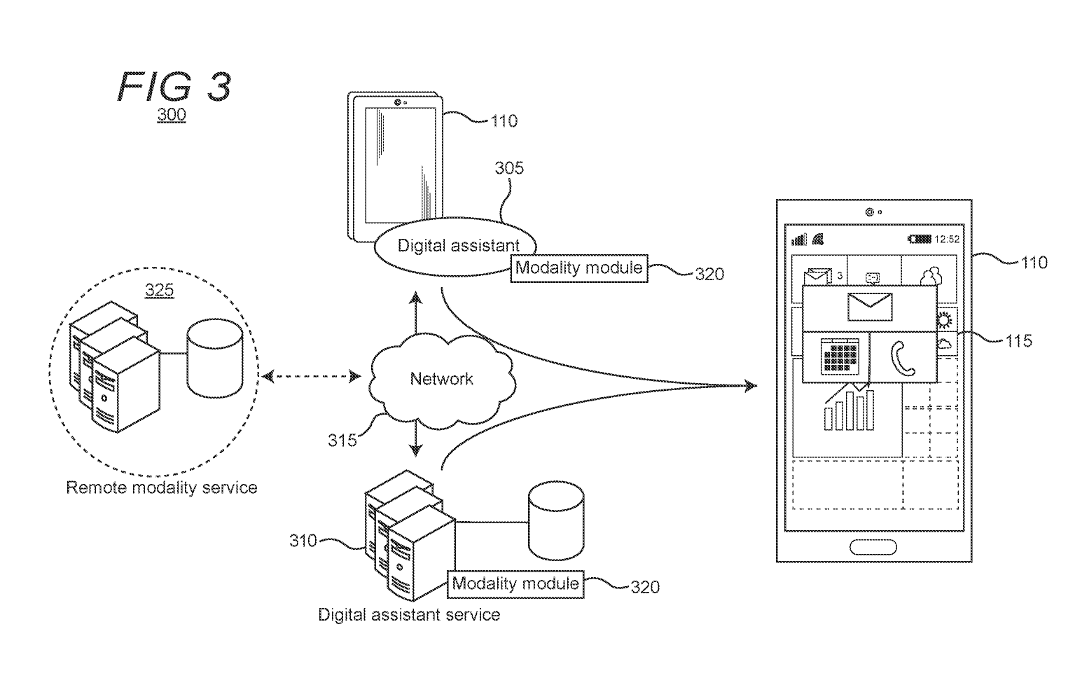

FIG. 3 shows an illustrative environment 300 in which a device 110 interoperates with a digital assistant 305 that automatically adjusts a modality for the display 115 of the device in response to applicable context and/or user interactions. The device may host the digital assistant 305 locally, access a digital assistant service 310 over network 315 which provides remote execution of digital assistant functionality, or the device may use a combination of local and remote execution for the digital assistant. The network 315 may include any environment, components, or infrastructure that provides connections to devices at network nodes and may include personal area network (PAN), local area network (LAN), wide area network (WAN), the Internet, World Wide Web, etc., and combinations thereof

The digital assistant may include a modality module 320 that is configured to store, create, add, delete, and adjust various modalities to display on a user's device. The modality module may be a component of the digital assistant that operates locally and/or remotely.

Alternatively, the modality module may be separately instantiated from the device and digital assistant, for example, by independent operation on a server, as illustratively depicted by the remote modality service 325. Therefore, the adjustment, creation, deletion, etc. of modalities may be implemented by any one or combination of the local or remote digital assistants along with the local or remote modality service, as may be needed to a suit a particular embodiment.

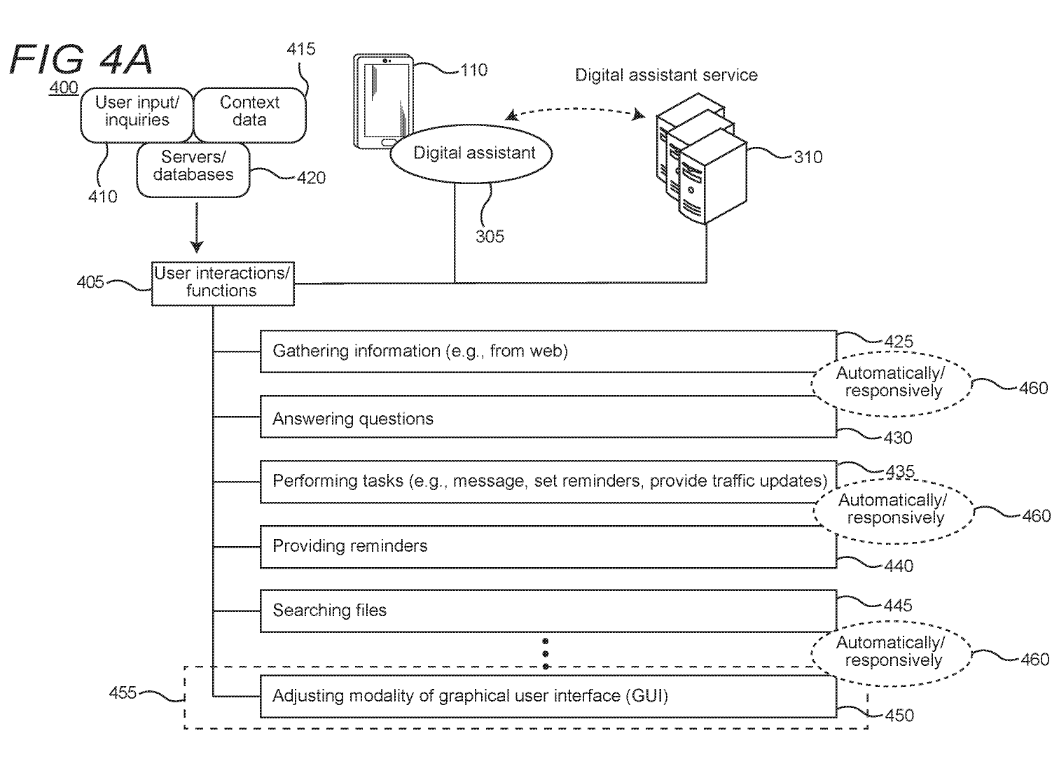

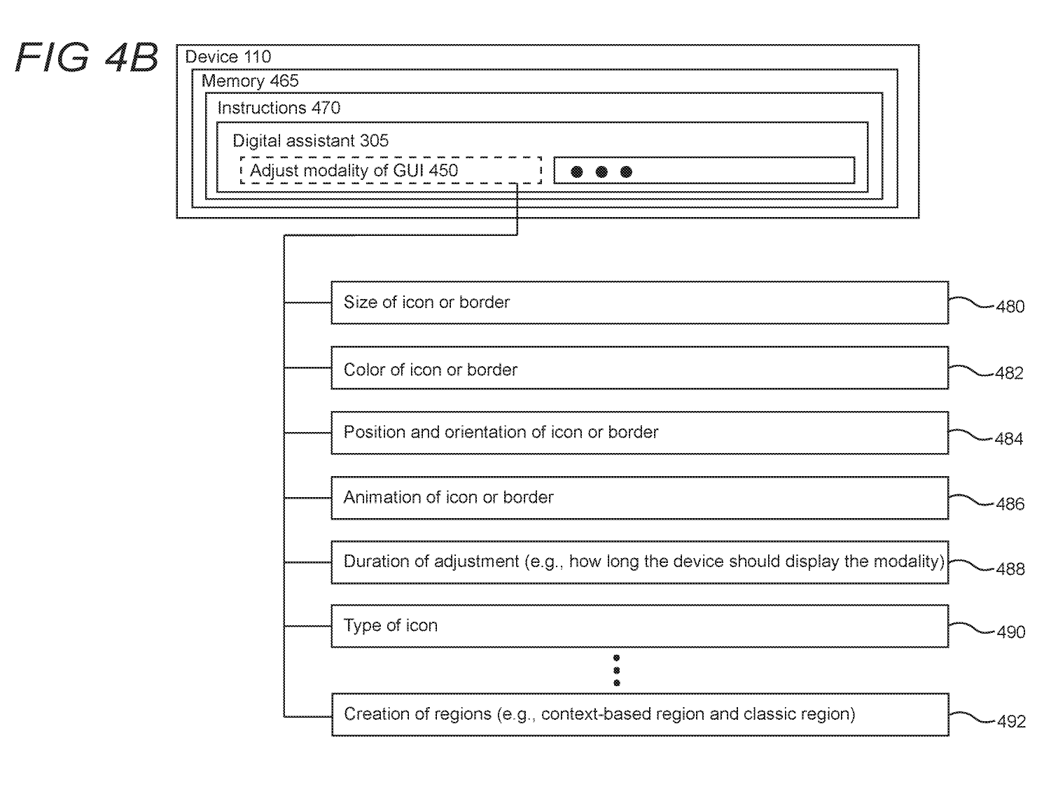

FIG. 4A shows an illustrative architecture 400 in which the digital assistant 305 and/or digital assistant service 310 provide a taxonomy of functions and user interactions 405 based on data received from various sources. For example, sources and data that may be utilized by the digital assistant include user input and inquiries 410, context data 415 (e.g., location, behavioral patterns, message content), with notice to user and user consent, and information from servers/databases 420 (e.g., weather data, traffic updates, etc.). Functions performed by the digital assistant may include gathering information (e.g., from the web) 425, answering questions 430, performing tasks (e.g., message, set reminders, provide traffic updates) 435, providing reminders 440, searching files 445, and adjusting modality of GUI 450. The various functions may be performed by the digital assistant either automatically or responsively, for example, to a user inquiry, interaction, comment, or feedback (collectively indicated by reference numeral 460). FIG. 4B provides a taxonomy of exemplary modality adjustments as illustrated by a cut-out portion 455 in FIG. 4A.

The taxonomy of modality adjustments may be part of instructions 470 stored in memory 465 of the device 110, which is executable by one or more processors (FIG. 2). Types of modality adjustments include size of icon or border 480, color of icon or border 482, position and orientation of icon or border 484, animation of icon or border 486, duration of adjustment 488 (e.g., how long the device displays the modality), type of icon 490, and creation of regions 492 (e.g., active/context-based region and classic region).

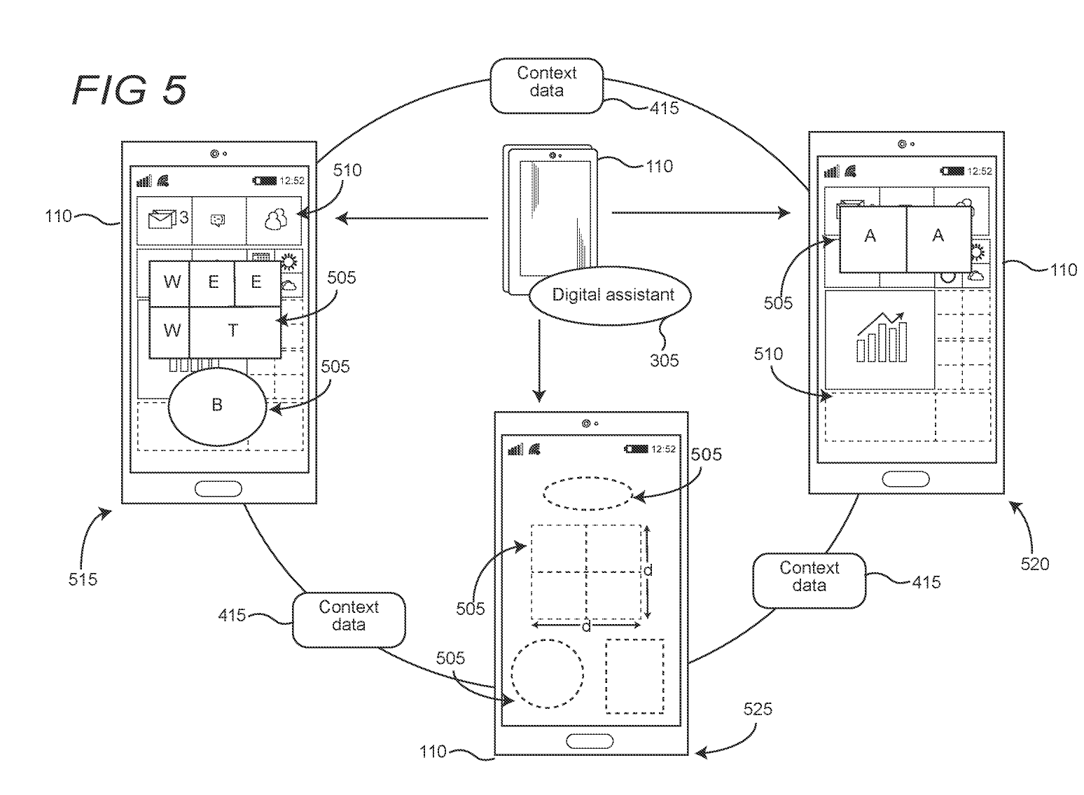

FIG. 5 shows illustrative modalities and presentations on devices 110 created by the digital assistant 305. For example, the various devices illustrate active/context-based regions 505 and classic regions 510 for exemplary modalities 515, 520, and 525. The active regions may be positioned in front of, or otherwise given more prominence to the user, than the classic regions. The classic regions may be positioned behind the active regions in some implementations using, for example, a conventional or default configuration for the icons.

In other exemplary embodiments, the digital assistant may create a single region that reconfigures a default modality such as the typical modality selected by the user. For example, the new modality may position relevant icons in a prominent manner within the default modality, and use additional space for the icons in the default modality.

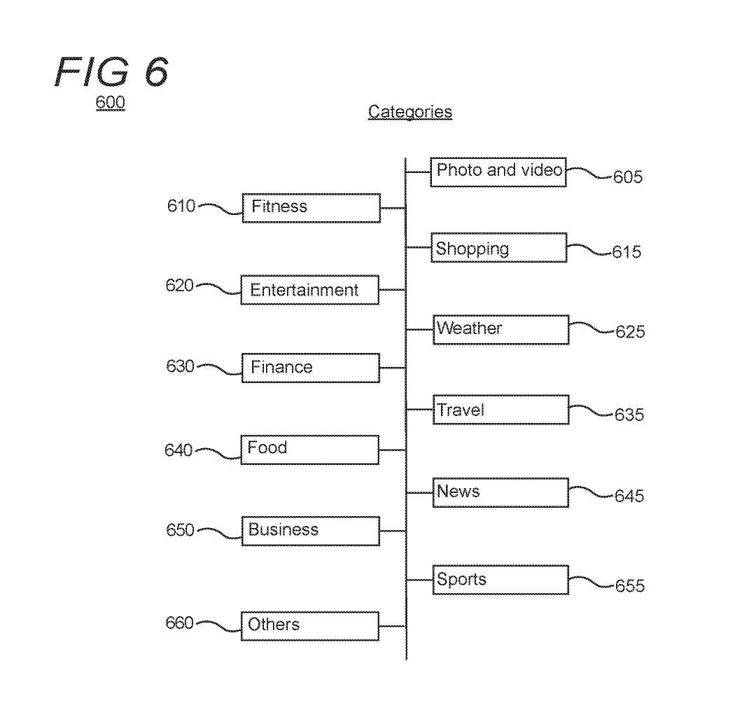

The letters (i.e., W, E, T, and A) depicted in the active regions of the example modalities 515 and 520 represent different categories that may be grouped together in certain embodiments. For example, FIG. 6 provides an exemplary, non-exhaustive list 600 of categories with which icons may be associated. For example, the categories include photo and video 605, fitness 610, shopping 615, entertainment 620, weather 625, finance 630, travel 635, food 640, news 645, business 650, sports 655, and others 660. Referring again to FIG. 5, modality 525 shows exemplary configurations to the shape, size, and position of graphical icons in created modalities, as described with respect to FIG. 4B.

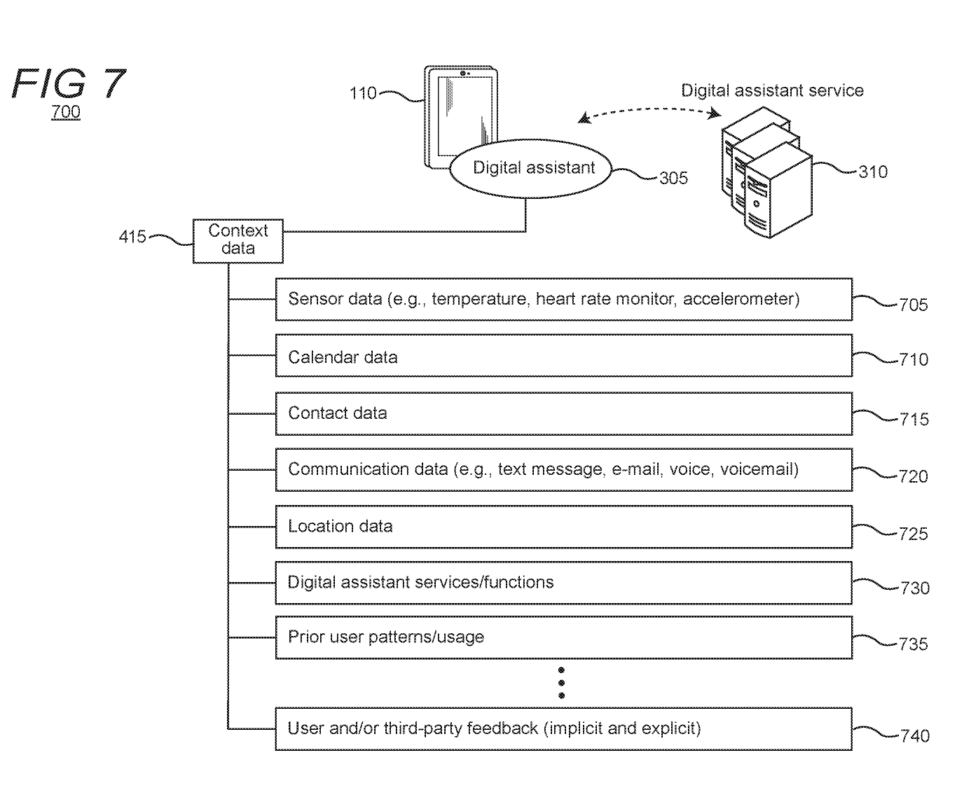

FIG. 7 shows an illustrative list 700 which describes context data 415. For example, the context data may include sensor data (e.g., thermometer, heart rate monitor, accelerometer) 705, calendar data 710, contact data 715, communication data (e.g., text message, e-mail, voice, voicemail) 720, location data 725, digital assistant services/functions 730, prior user patterns/usage 735, and user and/or third-party feedback (implicit or explicit) 740. The context data may be periodically monitored by the digital assistant, such as according to a pre-set time interval (e.g., every minute).

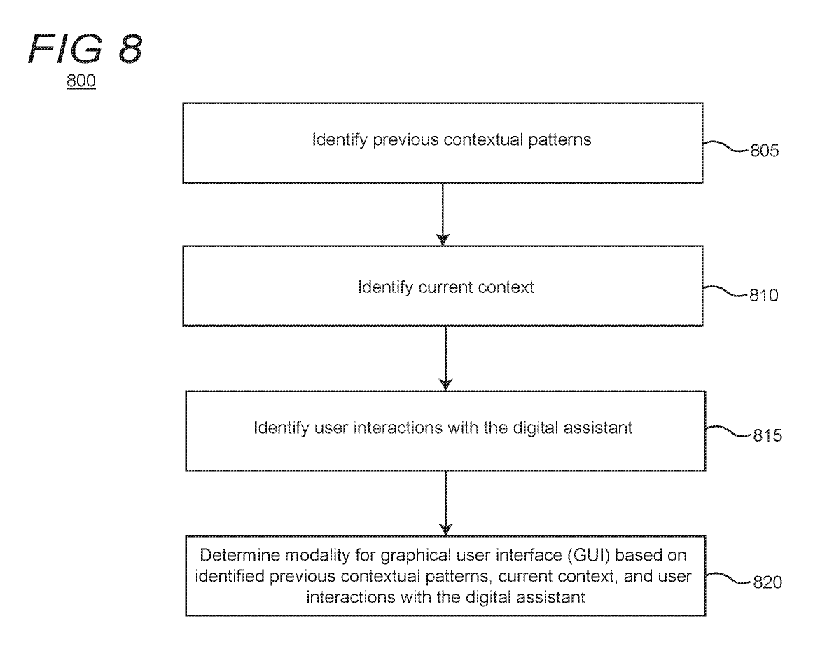

FIG. 8 provides an exemplary process 800 performed by a digital assistant to determine a modality for a GUI. For example, at step 805, the digital assistant can identify previous contextual patterns (e.g., applications used at particular times of day, applications used at certain locations, etc.). At step 810, the digital assistant may identify current context (e.g., location, message content with user consent, calendar data, etc.) At step 815 the digital assistant may identify user interactions with the digital assistant (e.g., user inquiries). At step 820, the digital assistant may determine a modality based on the identified previous contextual patterns, current context, and the user interactions with the digital assistant.

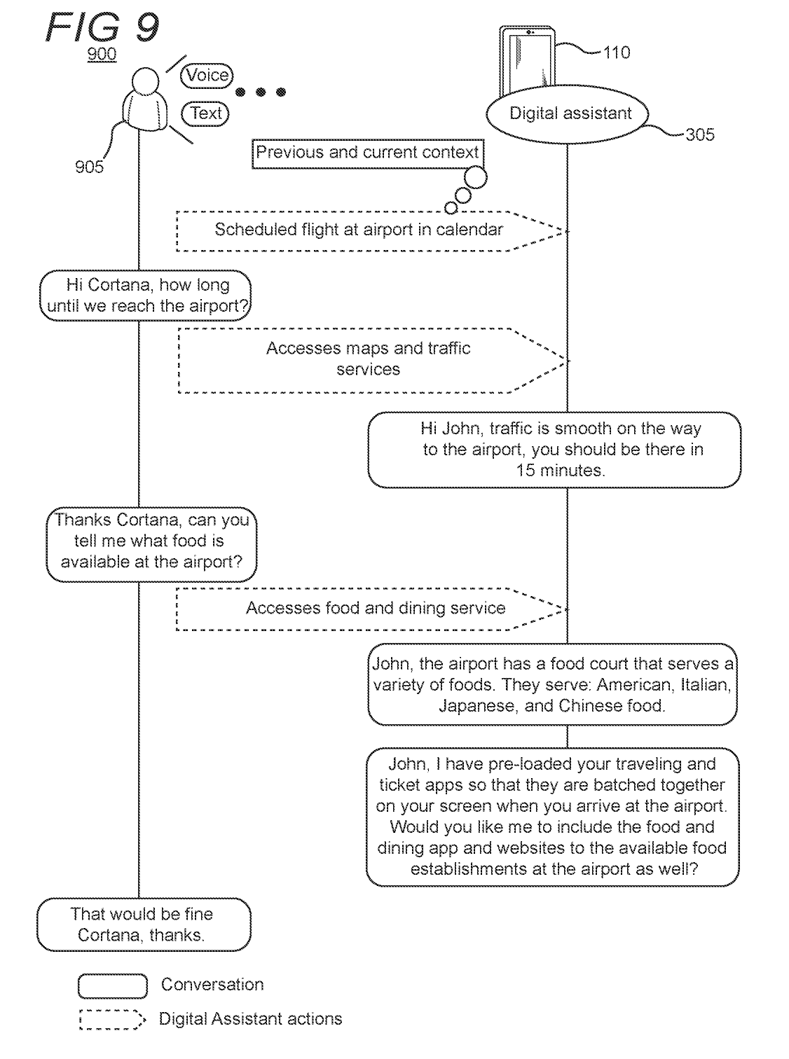

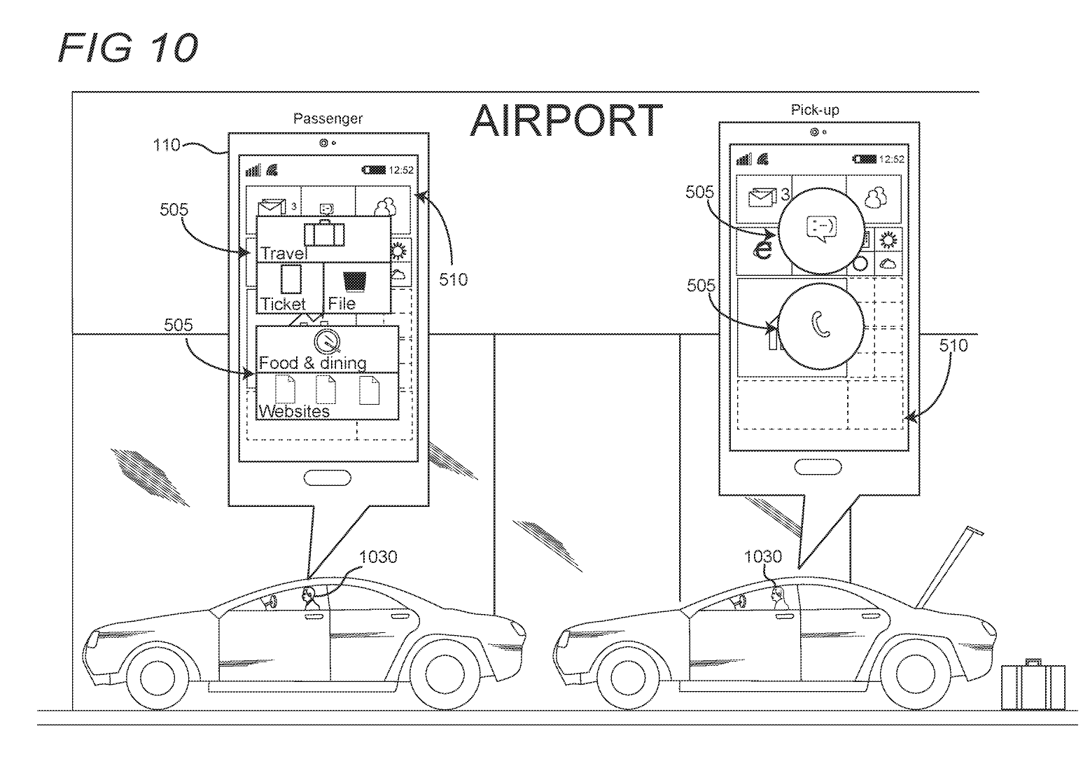

FIGS. 9 and 10 show an illustrative use scenario in which the digital assistant 305 provides a modality to a user based on context data and interactions with the user. For example, FIG. 9 provides illustrative user interactions 900 and processes at the digital assistant. In this scenario, the digital assistant observes, with the user's consent, the user's calendar data which shows that the user has a scheduled flight at the airport. In addition, the user requested information regarding what food is available at the airport. After the digital assistant provides the food information to the user, the digital assistant adjusts the modality of the GUI to include the food information.

For example, as user 130 is a passenger at an airport, the digital assistant creates a particular modality with various travel icons in an active region 505 of the display, as shown in FIG. 10. The digital assistant also includes food information with the travel icons in light of the user interactions illustrated in FIG. 9. In this scenario, the food icons include a food and dining application and websites associated with restaurants at the airport. The various travel icons include a travel application, ticket, and files that are related to the flight or trip. The classic region 510 can be located behind the active region 505.

The device associated with user 905 depicts various communication icons, such as a messenger and phone. The user 905 is picking up a passenger so therefore the applicable context analyzed by the digital assistant is different. In this scenario, the communication applications may be displayed to support convenient communications between the user 905 and the flight passenger that the user awaits to pick up.

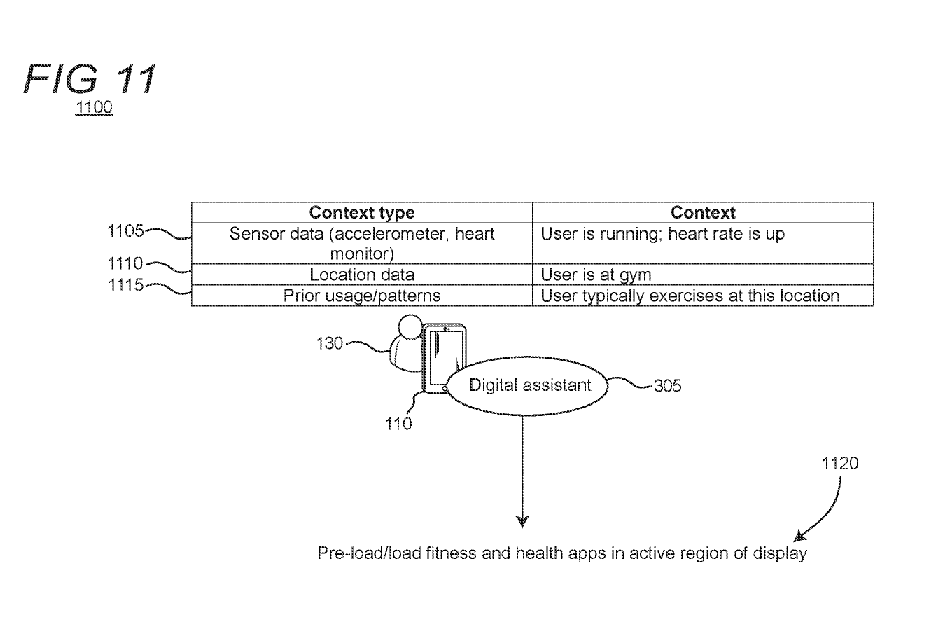

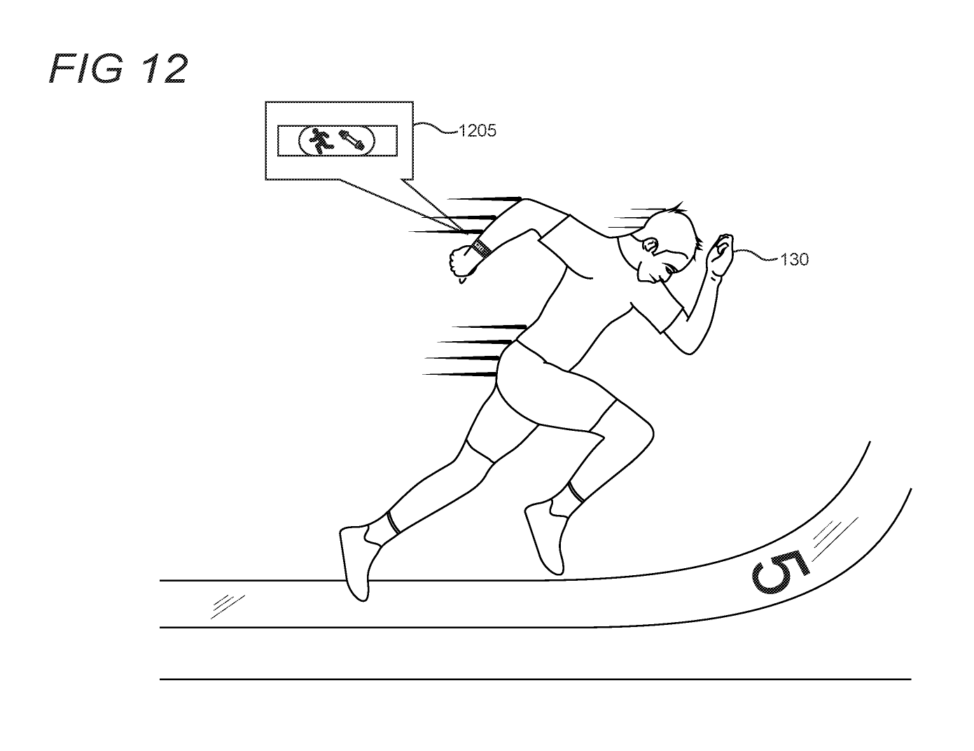

FIGS. 11 and 12 provide an illustrative use scenario of a modality employed on the user's wearable computing device such as band 1205 that is based on context data analyzed by the digital assistant 305. FIG. 11 is a chart 1100 that provides details on the context data utilized by the digital assistant. For example, the context data indicates that the user is running and his heart rate is elevated (based on signals from an accelerometer and heart rate monitor) 1105, the user is at a gym 1110, and prior use patterns illustrate that the user typically exercises at that location 1115. The digital assistant thus pre-loads/loads the fitness and health applications in the active region of the wearable band 1120. The digital assistant may pre-load the modality in anticipation of the user arriving at the gym or may immediately load the modality. FIG. 12 depicts the fitness and health applications as loaded on the user's wearable band while the user exercises.

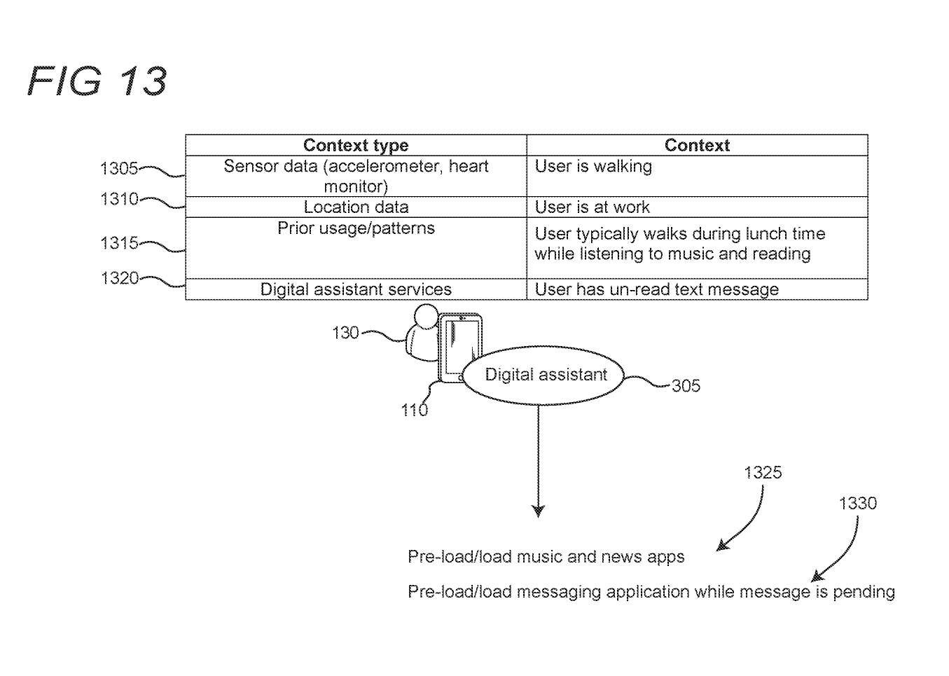

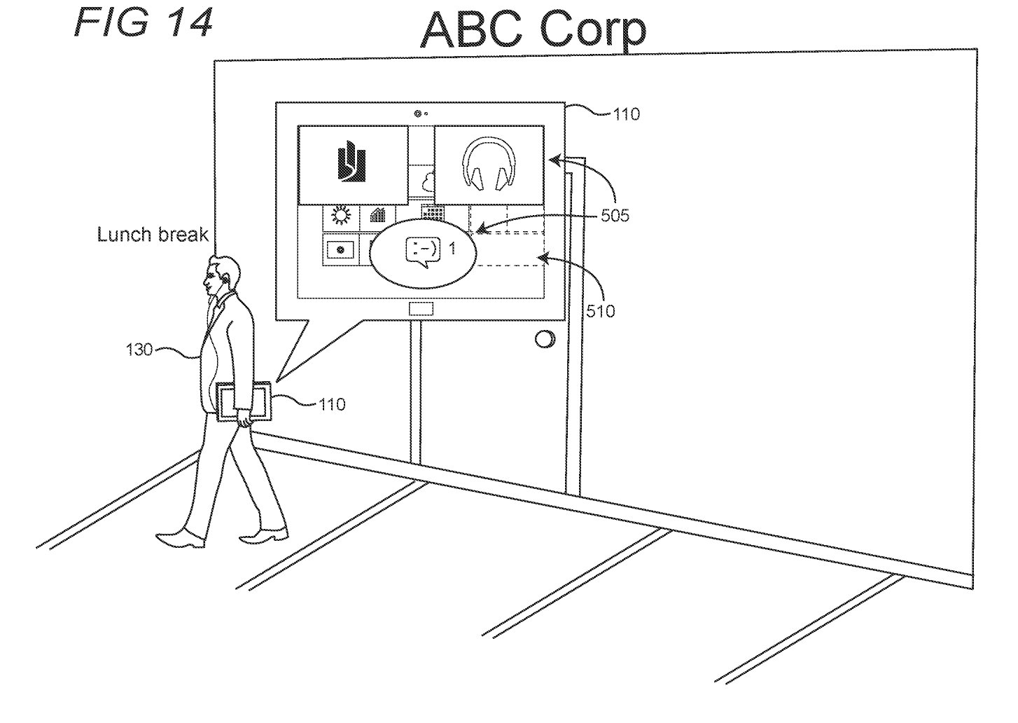

FIGS. 13 and 14 provide an illustrative use scenario of a modality on the user's tablet computer 110 based on context data analyzed by the digital assistant 305. FIG. 13 explains that the user is currently walking 1305, the user is at work 1310, the user typically walks and listens to music during lunch time 1315, and the user has an un-read text message 1320. In view of the context data, the digital assistant pre-loads or loads the music and news applications 1325 and pre-loads/loads the messenger application while the message is pending 1330.

The illustrative modality shown in FIG. 14 includes a reader icon, music icon, and a messenger icon in an active region 505 of the display. The active region is positioned in front of the classic region 510 in this example. Although the messenger application was not included in the user's prior usage/patterns, the unread message may still change the presentation of the modality (at least until the user acknowledges the message). For example, after the user acknowledges the message, the digital assistant may again change the modality to exclude the messenger icon. The digital assistant may also change the size, positioning, color, etc. of the reader and music icons after the messenger icon is excluded.

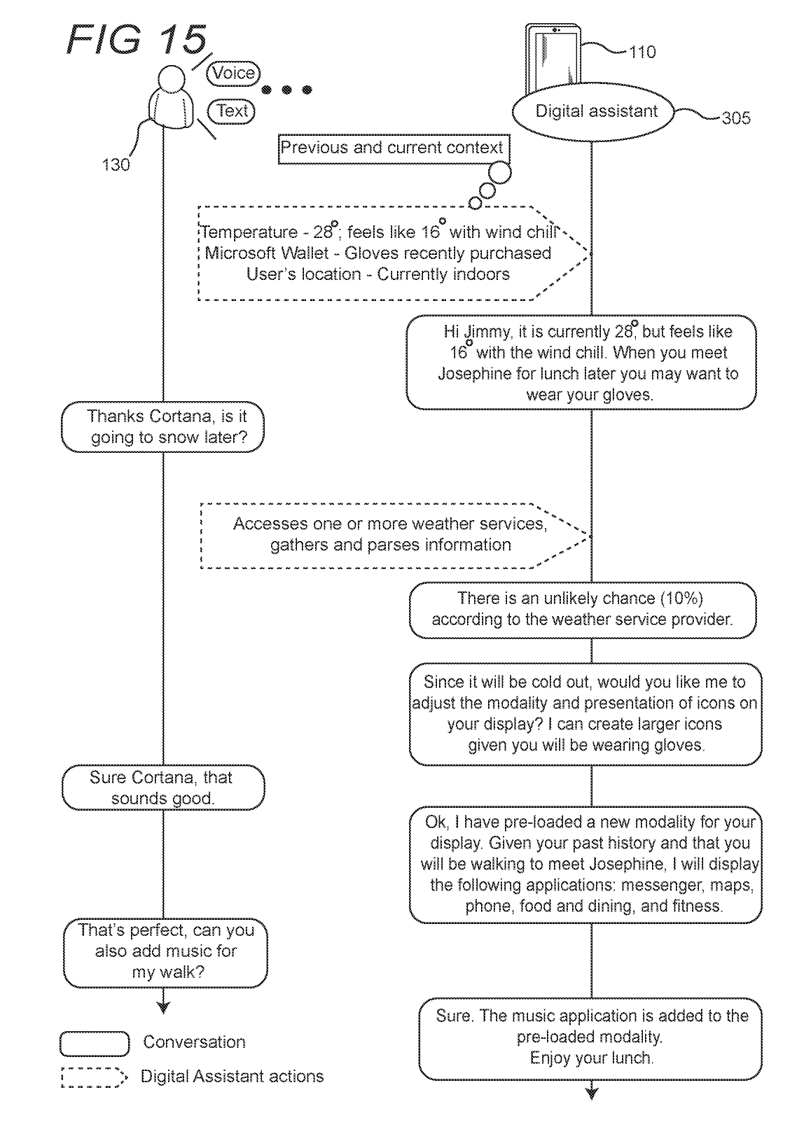

FIGS. 15-18 provide an illustrative use scenario in which the digital assistant 305 pre-loads multiple modalities based on context data and user interactions with the device. In this use scenario the digital assistant has gathered information that the temperature is below freezing, the user recently purchased gloves, and the user is currently located indoors. The digital assistant informs the user of the weather and suggests that the recently purchased gloves be worn. In addition, the digital assistant pre-loads a new modality of relevant icons in anticipation of the user's walk. The pre-loaded modality supports icons with increased size since the user is expected to be wearing gloves to thereby facilitate easier user interaction with the touchscreen display.

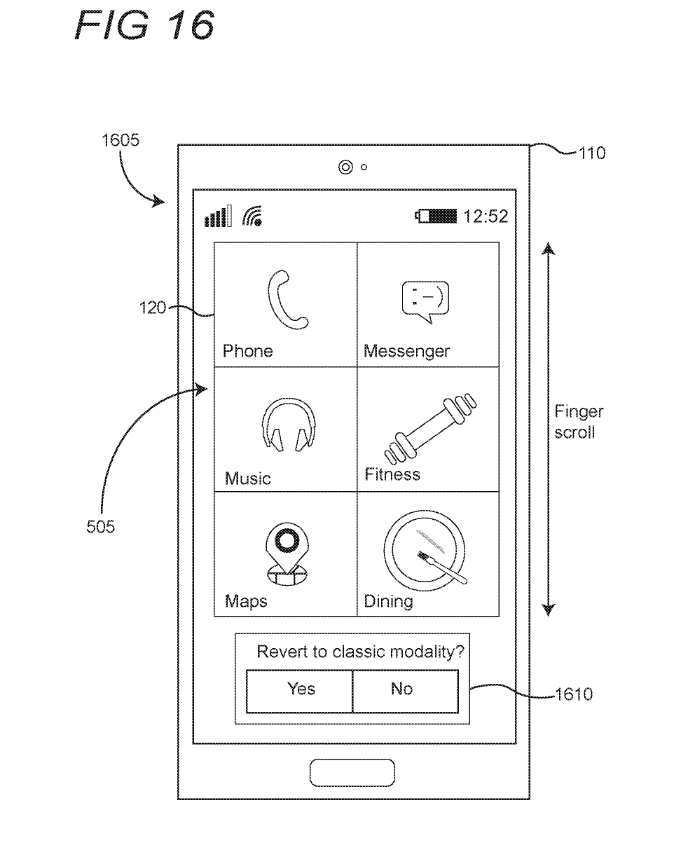

FIG. 16 shows an illustrative smartphone that displays the modality 1605 described above in which the relevant icons, including phone, messenger, music, fitness, maps, and dining, are larger in size. The placement of the icons may be considered as being in the active region 505. In addition, the display provides the user with an option to revert back to the classic modality 1610 (i.e., the default configuration for the icons).

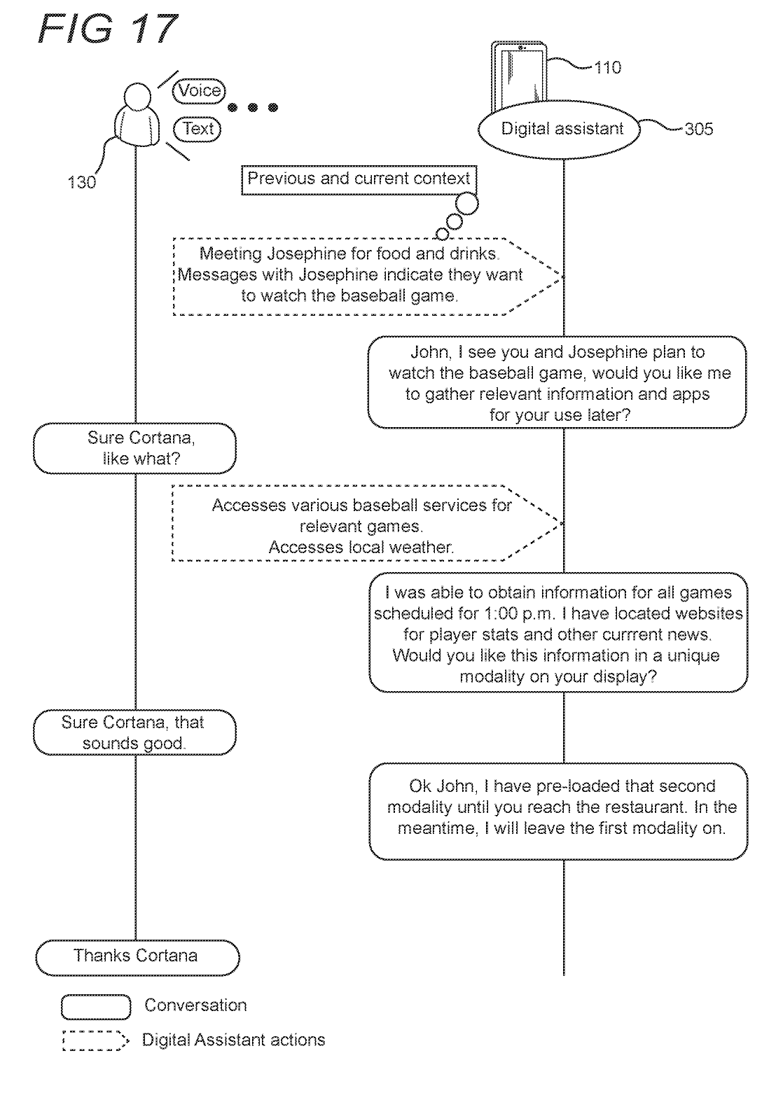

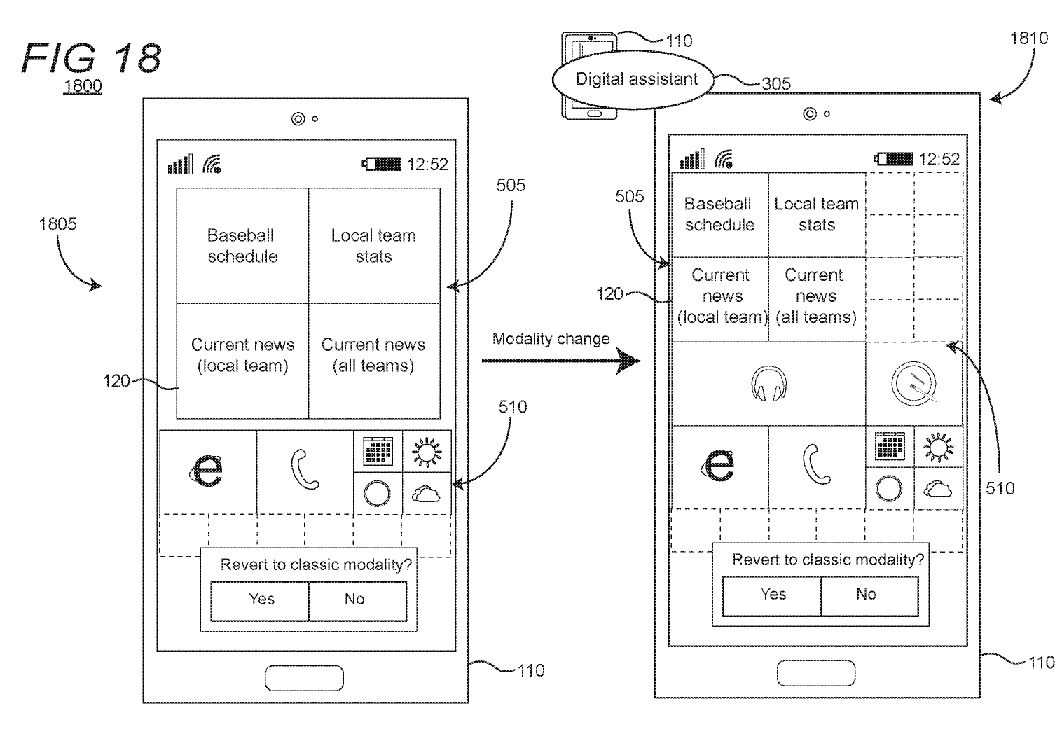

FIGS. 17 and 18 provide an additional use scenario pertaining to an event that occurs temporally subsequent to the scenario shown in FIGS. 15 and 16. In this scenario, the digital assistant observes, with the user's prior consent, that the user and his friend plan to watch a baseball game at the restaurant. In various interactions with the user, the digital assistant confirms the information with the user, and then gathers relevant information from various services over the network.

For example, as shown in the modality 1805 in FIG. 18, the digital assistant displays graphical icons that can direct the user to a baseball schedule, local team statistics, and current news for local and all teams. The active region 505 is positioned at a top portion of the display, and the classic region 510 is positioned below the active region. The user is also provided with an option to revert to the classic modality.

Modality 1810 in FIG. 18 is another exemplary modality that the digital assistant may create. The digital assistant may create the modality 1805 when the temperature is cold and the user wears gloves. In contrast, when the user is no longer wearing gloves, the digital assistant may adjust the modality to provide more convenience for the user using, for example, the classic modality for the icons (e.g., the default configuration of icons for the user). While the icons in modalities 1805 and 1810 represent the same applications, the digital assistant makes adjustments in style (e.g., size, shape, position) of the icons to create a new modality. Thus, changes in virtually any aspect of the configuration of the GUI can be considered a new modality.

The adaptive varying of modalities based on context as shown in FIG. 18 can also apply to HIVID devices. An HMD device can be configured to display groups of icons in a similar manner as the smartphone device as shown in FIG. 18, and adjust the modality of the icons based on context. In addition, HMD devices can be configured to create augmented reality or virtual reality environments for a user, and accordingly change the position, size, orientation, etc. of virtual objects imposed on the display of the HIVID device. A virtual object can include any type of object, for example, avatars, musical instruments, sporting goods, etc. Adjusting modalities on an HIVID device based on context data can include changing various features that are displayed on the HIVID device. For example, while rendering virtual objects and icons, the HIVID device can alter the size, shape, color, position, and the like of one or both of the icons and the virtual object based on the context data. If there are any applications that are executing, the HIVID device may also make an adjustment to the display of the application based on the context data.

In an embodiment, virtual objects imposed by the HIVID device in a real world canvas may vary the size of the objects depending on the time of day based on the understanding that users become tired as the day progresses. For example, virtual objects that are relatively smaller early in the morning and in the afternoon may be rendered relatively larger as the evening approaches to accommodate a user's potentially tired eyes. In another example, if sensor data detects that the user is walking or running, virtual objects may be changed or adjusted to accommodate the moving conditions. The HIVID device may enlarge the rendered virtual objects, emphasize the virtual object (e.g., highlight, change color, animate, bold), move the virtual object to the center of the display so the user does not need to search for the object, and the like.

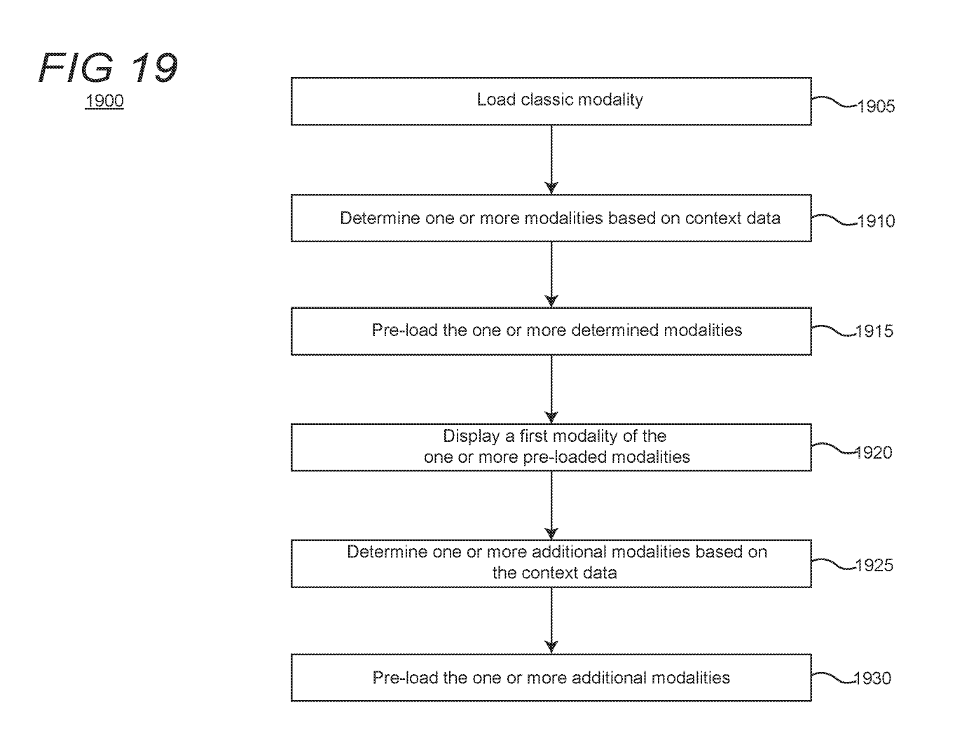

FIG. 19 shows an illustrative process 1900 performed by the digital assistant, with which the scenarios of FIGS. 15-18 may be implemented. At step 1905, the digital assistant loads the classic modality (e.g., the default configuration of icons for the user). At step 1910, the digital assistant determines one or more modalities based on context data (e.g., digital assistant user interactions, location data, calendar data, etc.). At step 1915, the digital assistant pre-loads one more of the determined modalities. At step 1920, the digital assistant displays a first modality of the one or more pre-loaded modalities. At step 1925, the digital assistant determines one or more additional modalities based on the context data. At step 1930, the digital assistant pre-loads the one or more additional modalities.

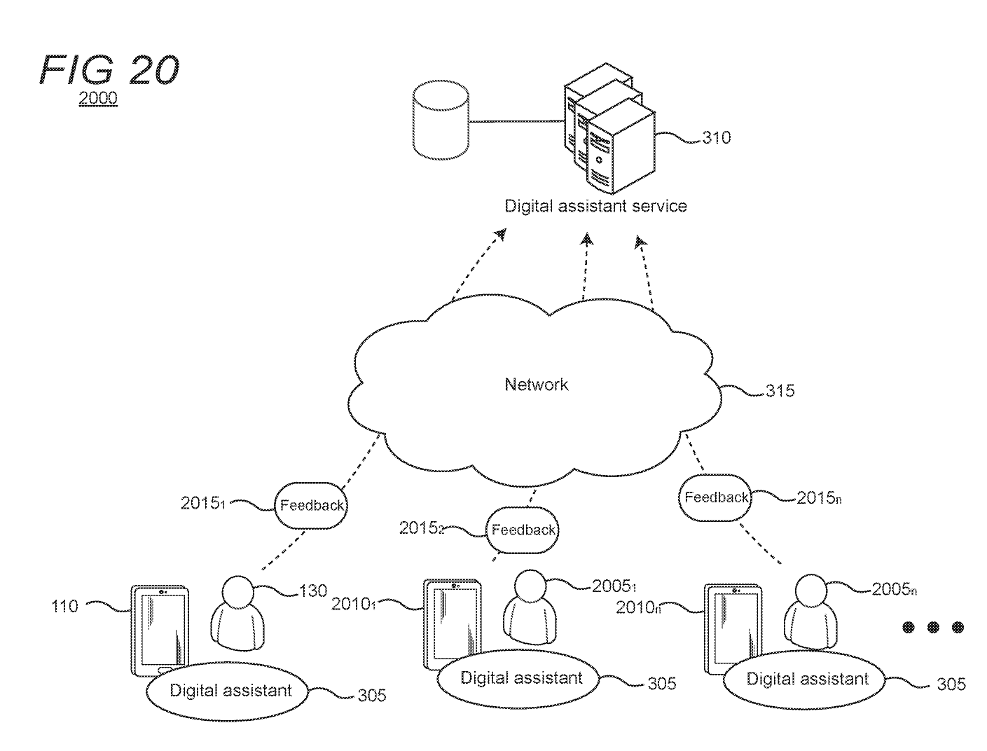

FIGS. 20-25 show an illustrative scenario in which one or more users of devices 2010 provide feedback about a modality. For example, FIG. 20 shows an illustrative environment 2000 in which various users 130 and 2005 provide feedback 2015 to the digital assistant service 310. In this example, the local digital assistant 305 may transmit the feedback to the service over the network 315.

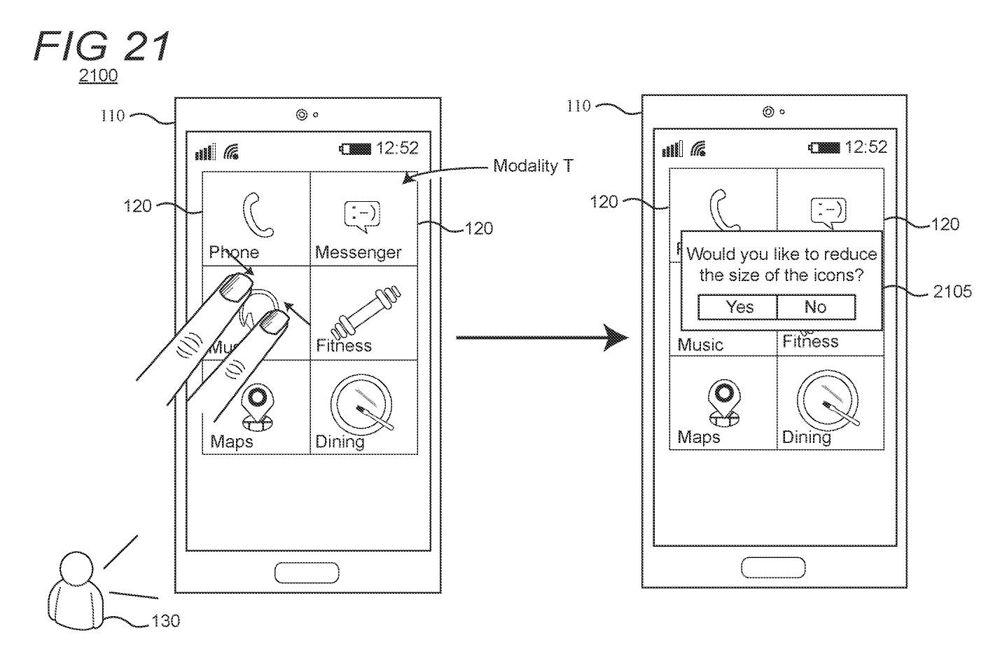

FIG. 21 shows an illustrative example 2100 of the user 130 adjusting a particular modality, modality T, in which the adjustment is used as feedback. For example, the user motions his fingers across the touch screen display of the device to indicate a reduction in the size of the graphical icons 120. In response, the digital assistant verifies with the user that he wishes to reduce the size of the icons 2105.

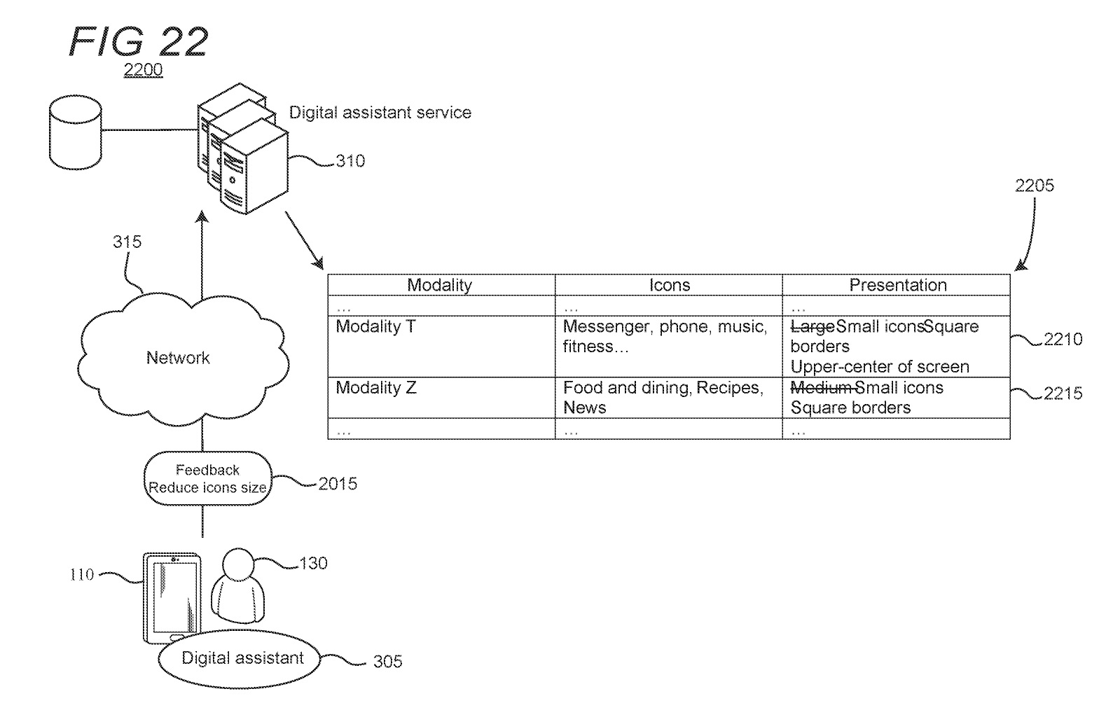

FIG. 22 shows an illustrative environment 2200 in which the digital assistant service 310 updates its database when the user approves the inquiry shown in FIG. 21. For example, when the user approves the size reduction of the icons, the feedback 2015 is transmitted over the network to the service. Table 2205 graphically shows the update to the icon size, as illustrated at row 2210.

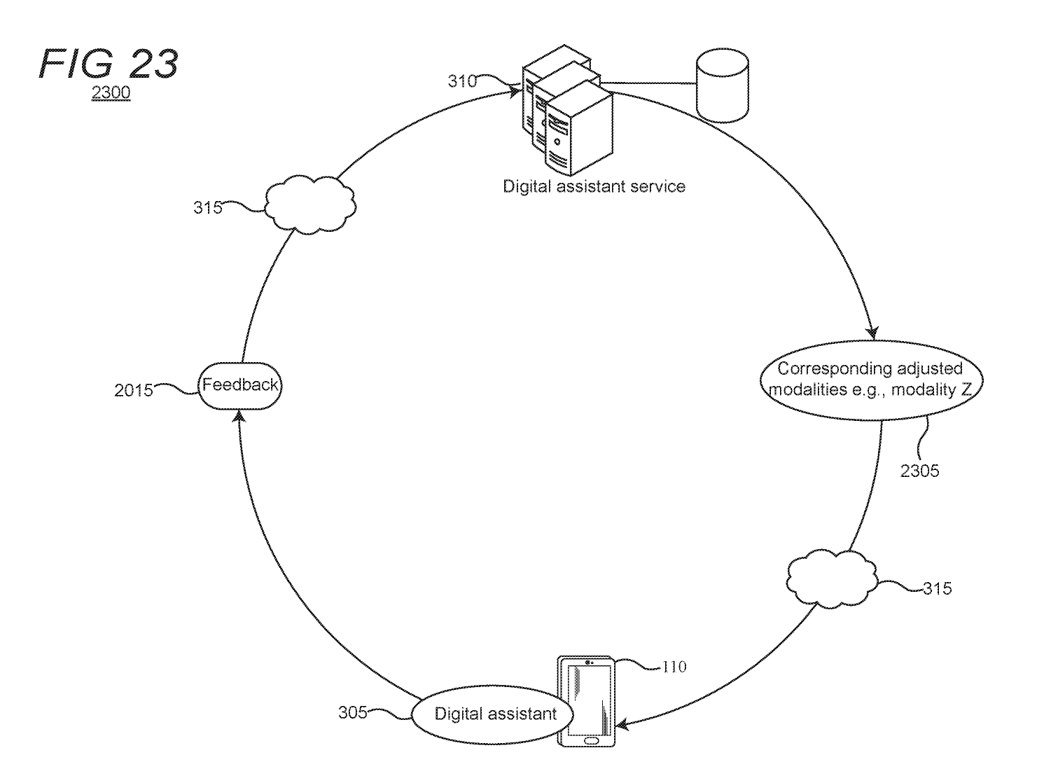

FIG. 23 shows an illustrative environment 2300 in which the digital assistant service transmits additional updates to the device 110. For example, after the update to modality T, the service can also update additional modalities that correspond to or otherwise include a similar design as modality T. As one example, the service adjusts the size of the icons for modality Z, as depicted at row 2215 of FIG. 22. FIG. 23 shows that after the service updates one or more corresponding modalities with the user's feedback, the service transmits the adjusted modalities (e.g., modality Z) 2305 to the device.

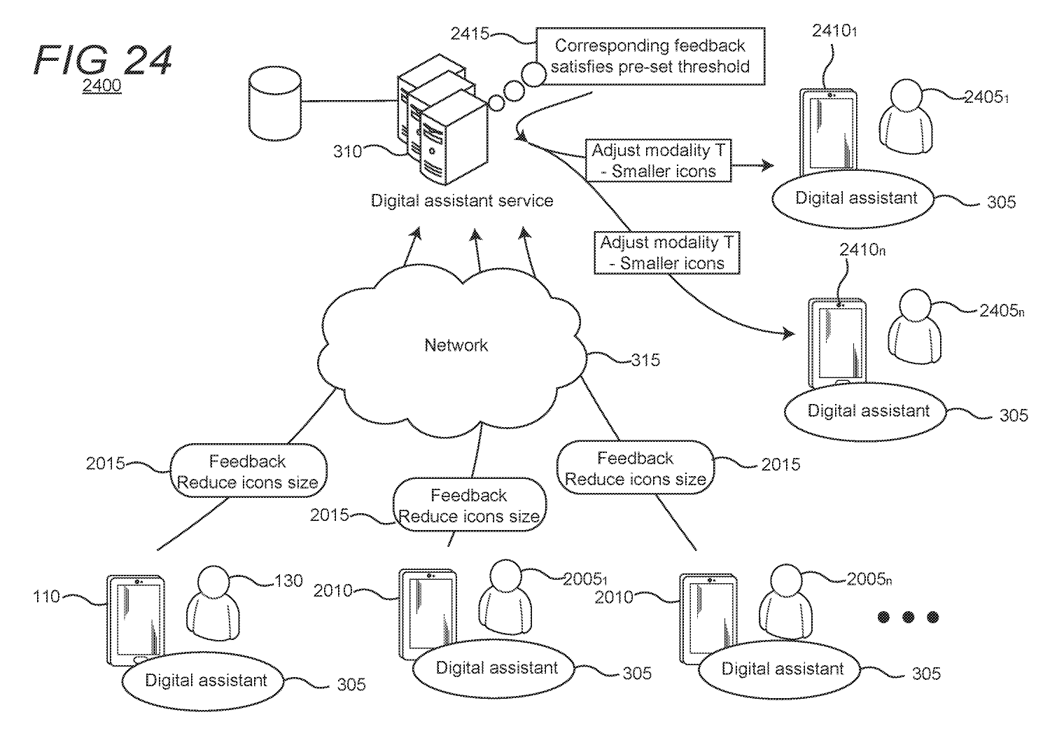

FIG. 24 shows an illustrative environment 2400 in which corresponding feedback 2015 from multiple users 130 and 2005 is transmitted to unrelated users 2405. In this example, the various users provide feedback comprising icon size adjustments. The service can determine if a predetermined threshold of corresponding feedback has been satisfied 2415. For example, the service may identify if there is a pattern in the feedback from the users, such as a predetermined number of users who made the same or similar adjustment (e.g., icon size adjustment). The predetermined threshold may be a percentage of users (e.g., 15%) or a number of users (e.g., 5,000) who provide corresponding feedback. Other adjustments may include changes in color, animation, position, orientation, and type of icon and/or the regions of the modality (FIG. 4B).

When the service determines that the threshold is met, the service transmits the update (e.g., feedback) to devices of the other unrelated users 2405. The unrelated users may be users who have not utilized the adjusted modality or users who have not provided feedback regarding the adjusted modality. In addition, the service may apply the feedback to related modalities (e.g., similar size, position, or color of icon) as well. When the service adjusts related modalities then the related modalities may also be transmitted to the devices of the other unrelated users.

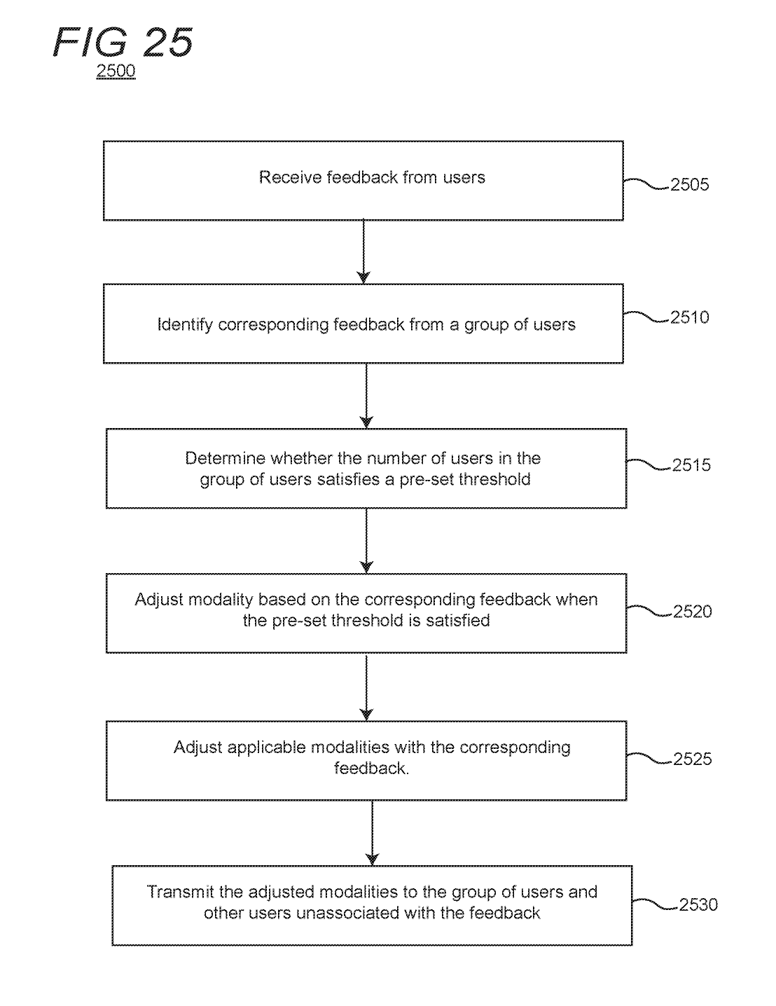

FIG. 25 shows an illustrative process 2500 which may be executed by the digital assistant service 310. At step 2505, the service may receive feedback (implicit or explicit) from users (e.g., adjustments to the icons, regions, GUI, etc.). At step 2510, the service may identify corresponding feedback from a group of users. Corresponding feedback can be similar adjustments made by unique users, such as a reduction in icon size, change of icon color, change of icon shape, change of icon position, etc. At step 2515 the service may determine whether the number of users in the group of users satisfies a pre-set threshold. For example, the pre-set threshold may be a percentage or number of users having corresponding or similar feedback. The pre-set threshold may be based on all the users who utilize the digital assistant or alternatively on all the users who have utilized that particular modality.

At step 2520, the service may adjust the modality associated with the corresponding feedback when the pre-set threshold is satisfied. At step 2525, the service may adjust applicable modalities with the corresponding feedback. Applicable modalities may include modalities that have similar features as the adjusted modality, such as shape, color, size, or position of icon. At step 2530, the service transmits the adjusted modalities to the group of users and other users unassociated with the feedback. The users unassociated with the feedback may be users who have not yet provided feedback for that modality or have not yet utilized that modality.

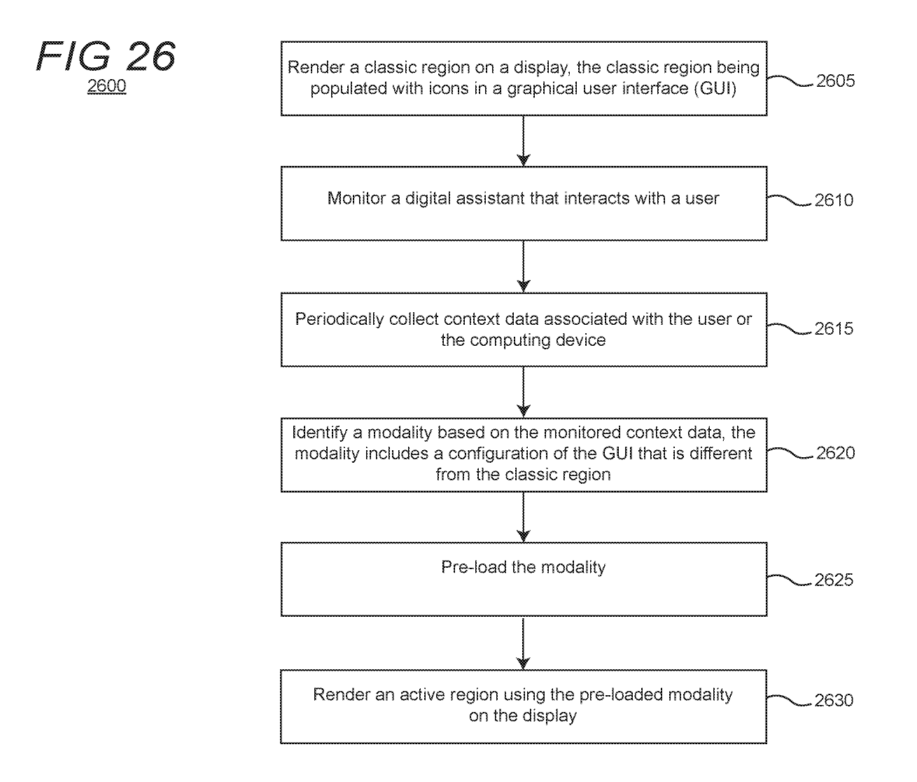

FIG. 26 is a flowchart of an illustrative method 2600 to render a tailored modality on a display of a computing device for a user. Unless specifically stated, methods or steps shown in the flowcharts and described in the accompanying text are not constrained to a particular order or sequence. In addition, some of the methods or steps thereof can occur or be performed concurrently and not all the methods or steps have to be performed in a given implementation depending on the requirements of such implementation and some methods or steps may be optionally utilized.

In step 2605, a classic region on a display is rendered, in which the classic region is populated with icons in a GUI. In step 2610, interactions between a user and a digital assistant are monitored. In step 2615, the digital assistant periodically collects context data associated with the user or the computing device. The context data can at least partially be collected from the interactions between the digital assistant and the user. In step 2620, a modality is identified based on the monitored context data. The modality includes a configuration of the GUI that is different from the classic region. In step 2625, the modality is pre-loaded. In step 2630, an active region is rendered on the display using the pre-loaded modality.

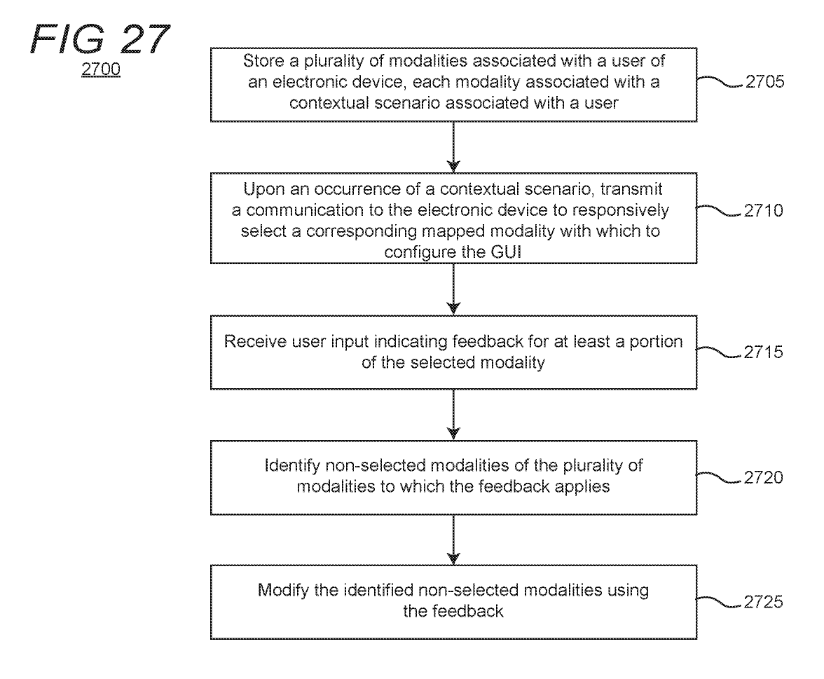

FIG. 27 is a method 2700 performed by an electronic device. In step 2705, a plurality of modalities is stored. The modalities are associated with a user of the electronic device, and each modality is associated with a scenario associated with the user. In step 2710, upon an occurrence of a contextual scenario, a communication is transmitted to the electronic device. The communication is sent for the user to responsively select a corresponding mapped modality with which to configure the GUI. In step 2715, user input is received which indicates feedback for at least a portion of the selected modality. In step 2720, non-selected modalities are identified from the plurality of modalities. These non-selected modalities may be modalities in which the feedback applies. In step 2725, the identified non-selected modalities are modified using the feedback.

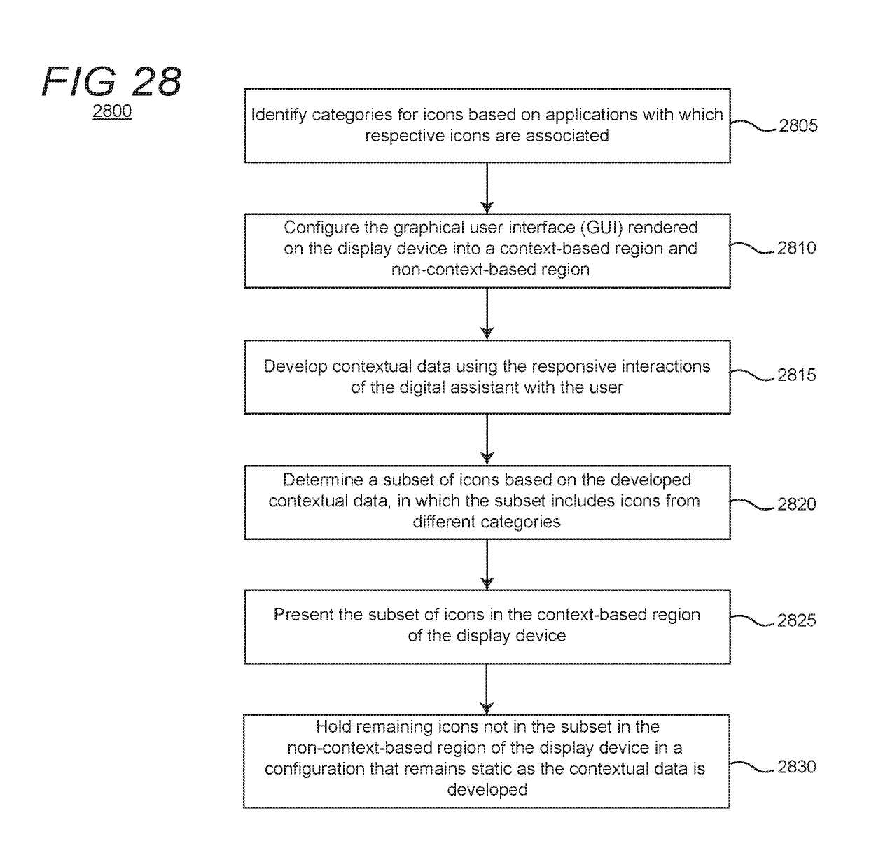

FIG. 28 is a method 2800 that can be performed on a mobile computing device. In step 2805, categories for icons are identified based on applications with which respective icons are associated. In step 2810, a rendered GUI is configured on the display device into a context-based region and a non-context-based region. In step 2815, contextual data is developed using the responsive interactions of the digital assistant with the user. In step 2820, a subset of icons is determined based on the developed contextual data. The subset includes icons from different categories (FIG. 6). In step 2825, the subset of icons is presented in the context-based region of the display device. Finally, at step 2830 remaining icons not in the subset are held in the non-context-based region of the display device. These icons may be held in a configuration that remains static as the contextual data is developed.

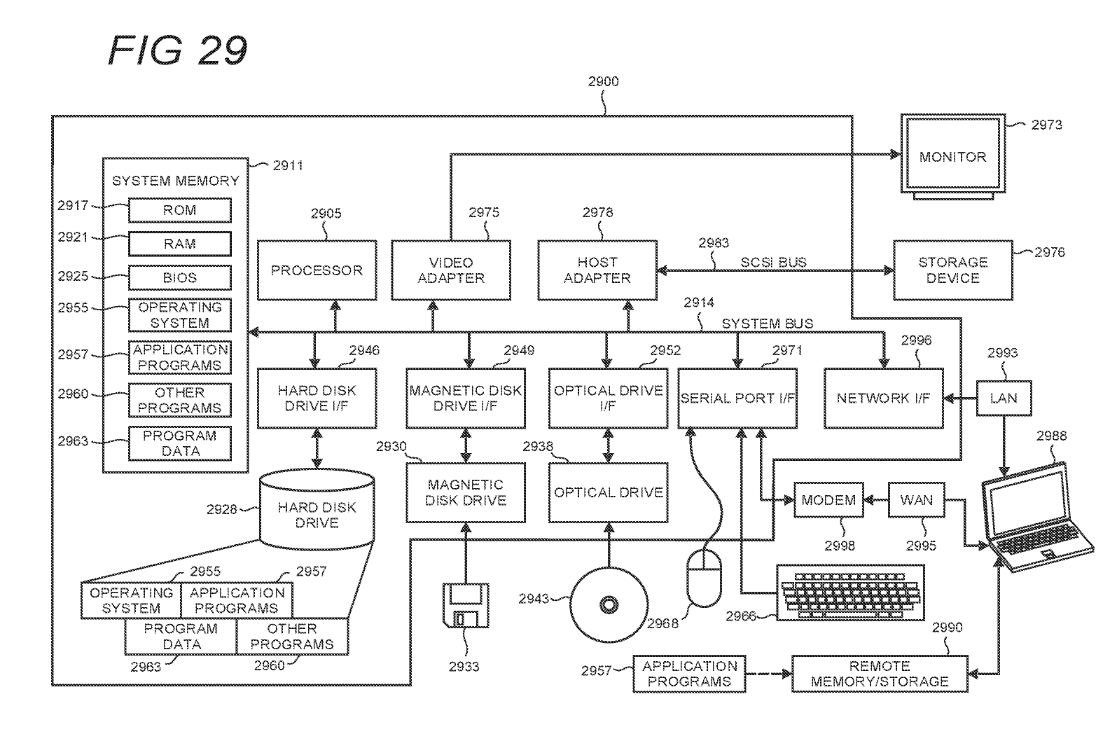

FIG. 29 is a simplified block diagram of an illustrative computer system 2900 such as a PC, client machine, laptop computer, or server with which the present varying modality of user experiences based on context is utilized. Computer system 2900 includes a processor 2905, a system memory 2911, and a system bus 2914 that couples various system components including the system memory 2911 to the processor 2905. The system bus 2914 may be any of several types of bus structures including a memory bus or memory controller, a peripheral bus, or a local bus using any of a variety of bus architectures. The system memory 2911 includes read only memory (ROM) 2917 and random access memory (RAM) 2921. A basic input/output system (BIOS) 2925, containing the basic routines that help to transfer information between elements within the computer system 2900, such as during startup, is stored in ROM 2917. The computer system 2900 may further include a hard disk drive 2928 for reading from and writing to an internally disposed hard disk (not shown), a magnetic disk drive 2930 for reading from or writing to a removable magnetic disk 2933 (e.g., a floppy disk), and an optical disk drive 2938 for reading from or writing to a removable optical disk 2943 such as a CD (compact disc), DVD (digital versatile disc), or other optical media. The hard disk drive 2928, magnetic disk drive 2930, and optical disk drive 2938 are connected to the system bus 2914 by a hard disk drive interface 2946, a magnetic disk drive interface 2949, and an optical drive interface 2952, respectively. The drives and their associated computer-readable storage media provide non-volatile storage of computer-readable instructions, data structures, program modules, and other data for the computer system 2900. Although this illustrative example includes a hard disk, a removable magnetic disk 2933, and a removable optical disk 2943, other types of computer-readable storage media which can store data that is accessible by a computer such as magnetic cassettes, Flash memory cards, digital video disks, data cartridges, random access memories (RAMs), read only memories (ROMs), and the like may also be used in some applications of the present varying modality of user experiences based on context. In addition, as used herein, the term computer-readable storage media includes one or more instances of a media type (e.g., one or more magnetic disks, one or more CDs, etc.). For purposes of this specification and the claims, the phrase “computer-readable storage media” and variations thereof, does not include waves, signals, and/or other transitory and/or intangible communication media.

A number of program modules may be stored on the hard disk 2928, magnetic disk 2930, optical disk 2938, ROM 2917, or RAM 2921, including an operating system 2955, one or more application programs 2957, other program modules 2960, and program data 2963. A user may enter commands and information into the computer system 2900 through input devices such as a keyboard 2966 and pointing device 2968 such as a mouse. Other input devices (not shown) may include a microphone, joystick, game pad, satellite dish, scanner, trackball, touchpad, touchscreen, touch-sensitive device, voice-command module or device, user motion or user gesture capture device, or the like. These and other input devices are often connected to the processor 2905 through a serial port interface 2971 that is coupled to the system bus 2914, but may be connected by other interfaces, such as a parallel port, game port, or universal serial bus (USB). A monitor 2973 or other type of display device is also connected to the system bus 2914 via an interface, such as a video adapter 2975. In addition to the monitor 2973, personal computers typically include other peripheral output devices (not shown), such as speakers and printers. The illustrative example shown in FIG. 29 also includes a host adapter 2978, a Small Computer System Interface (SCSI) bus 2983, and an external storage device 2976 connected to the SCSI bus 2983.

The computer system 2900 is operable in a networked environment using logical connections to one or more remote computers, such as a remote computer 2988. The remote computer 2988 may be selected as another personal computer, a server, a router, a network PC, a peer device, or other common network node, and typically includes many or all of the elements described above relative to the computer system 2900, although only a single representative remote memory/storage device 2990 is shown in FIG. 29. The logical connections depicted in FIG. 29 include a local area network (LAN) 2993 and a wide area network (WAN) 2995. Such networking environments are often deployed, for example, in offices, enterprise-wide computer networks, intranets, and the Internet.

When used in a LAN networking environment, the computer system 2900 is connected to the local area network 2993 through a network interface or adapter 2996. When used in a WAN networking environment, the computer system 2900 typically includes a broadband modem 2998, network gateway, or other means for establishing communications over the wide area network 2995, such as the Internet. The broadband modem 2998, which may be internal or external, is connected to the system bus 2914 via a serial port interface 2971. In a networked environment, program modules related to the computer system 2900, or portions thereof, may be stored in the remote memory storage device 2990. It is noted that the network connections shown in FIG. 29 are illustrative and other methods of establishing a communications link between the computers may be used depending on the specific requirements of an application of the present varying modality of user experiences with a mobile device based on context.

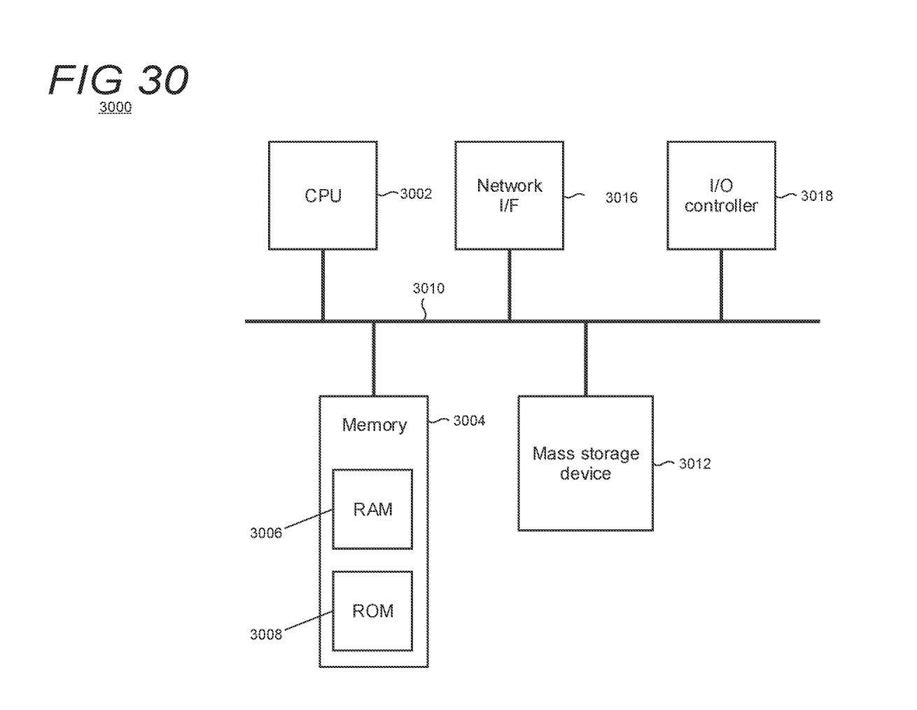

FIG. 30 shows an illustrative architecture 3000 for a device capable of executing the various components described herein for providing a varying modality of user experiences with a mobile device based on context. Thus, the architecture 3000 illustrated in FIG. 30 shows an architecture that may be adapted for a server computer, mobile phone, a PDA, a smartphone, a desktop computer, a netbook computer, a tablet computer, GPS device, game system, and/or a laptop computer. The architecture 3000 may be utilized to execute any aspect of the components presented herein.

The architecture 3000 illustrated in FIG. 30 includes a CPU (Central Processing Unit) 3002, a system memory 3004, including a RAM 3006 and a ROM 3008, and a system bus 3010 that couples the memory 3004 to the CPU 3002. A basic input/output system containing the basic routines that help to transfer information between elements within the architecture 3000, such as during startup, is stored in the ROM 3008. The architecture 3000 further includes a mass storage device 3012 for storing software code or other computer-executed code that is utilized to implement applications, the file system, and the operating system.

The mass storage device 3012 is connected to the CPU 3002 through a mass storage controller (not shown) connected to the bus 3010.The mass storage device 3012 and its associated computer-readable storage media provide non-volatile storage for the architecture 3000.

Although the description of computer-readable storage media contained herein refers to a mass storage device, such as a hard disk or CD-ROM drive, it may be appreciated by those skilled in the art that computer-readable storage media can be any available storage media that can be accessed by the architecture 3000.

By way of example, and not limitation, computer-readable storage media may include volatile and non-volatile, removable and non-removable media implemented in any method or technology for storage of information such as computer-readable instructions, data structures, program modules, or other data. For example, computer-readable media includes, but is not limited to, RAM, ROM, EPROM (erasable programmable read only memory), EEPROM (electrically erasable programmable read only memory), Flash memory or other solid state memory technology, CD-ROM, DVDs, HD-DVD (High Definition DVD), Blu-ray, or other optical storage, magnetic cassettes, magnetic tape, magnetic disk storage or other magnetic storage devices, or any other medium which can be used to store the desired information and which can be accessed by the architecture 3000.

According to various embodiments, the architecture 3000 may operate in a networked environment using logical connections to remote computers through a network. The architecture 3000 may connect to the network through a network interface unit 3016 connected to the bus 3010. It may be appreciated that the network interface unit 3016 also may be utilized to connect to other types of networks and remote computer systems. The architecture 3000 also may include an input/output controller 3018 for receiving and processing input from a number of other devices, including a keyboard, mouse, or electronic stylus (not shown in FIG. 30). Similarly, the input/output controller 3018 may provide output to a display screen, a printer, or other type of output device (also not shown in FIG. 30).

It may be appreciated that the software components described herein may, when loaded into the CPU 3002 and executed, transform the CPU 3002 and the overall architecture 3000 from a general-purpose computing system into a special-purpose computing system customized to facilitate the functionality presented herein. The CPU 3002 may be constructed from any number of transistors or other discrete circuit elements, which may individually or collectively assume any number of states. More specifically, the CPU 3002 may operate as a finite-state machine, in response to executable instructions contained within the software modules disclosed herein. These computer-executable instructions may transform the CPU 3002 by specifying how the CPU 3002 transitions between states, thereby transforming the transistors or other discrete hardware elements constituting the CPU 3002.

Encoding the software modules presented herein also may transform the physical structure of the computer-readable storage media presented herein. The specific transformation of physical structure may depend on various factors, in different implementations of this description. Examples of such factors may include, but are not limited to, the technology used to implement the computer-readable storage media, whether the computer-readable storage media is characterized as primary or secondary storage, and the like. For example, if the computer-readable storage media is implemented as semiconductor-based memory, the software disclosed herein may be encoded on the computer-readable storage media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable storage media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media to change the optical characteristics of those locations. Other transformations of physical media are possible without departing from the scope and spirit of the present description, with the foregoing examples provided only to facilitate this discussion.

In light of the above, it may be appreciated that many types of physical transformations take place in the architecture 3000 in order to store and execute the software components presented herein. It also may be appreciated that the architecture 3000 may include other types of computing devices, including handheld computers, embedded computer systems, smartphones, PDAs, and other types of computing devices known to those skilled in the art. It is also contemplated that the architecture 3000 may not include all of the components shown in FIG. 30, may include other components that are not explicitly shown in FIG. 30, or may utilize an architecture completely different from that shown in FIG. 30.

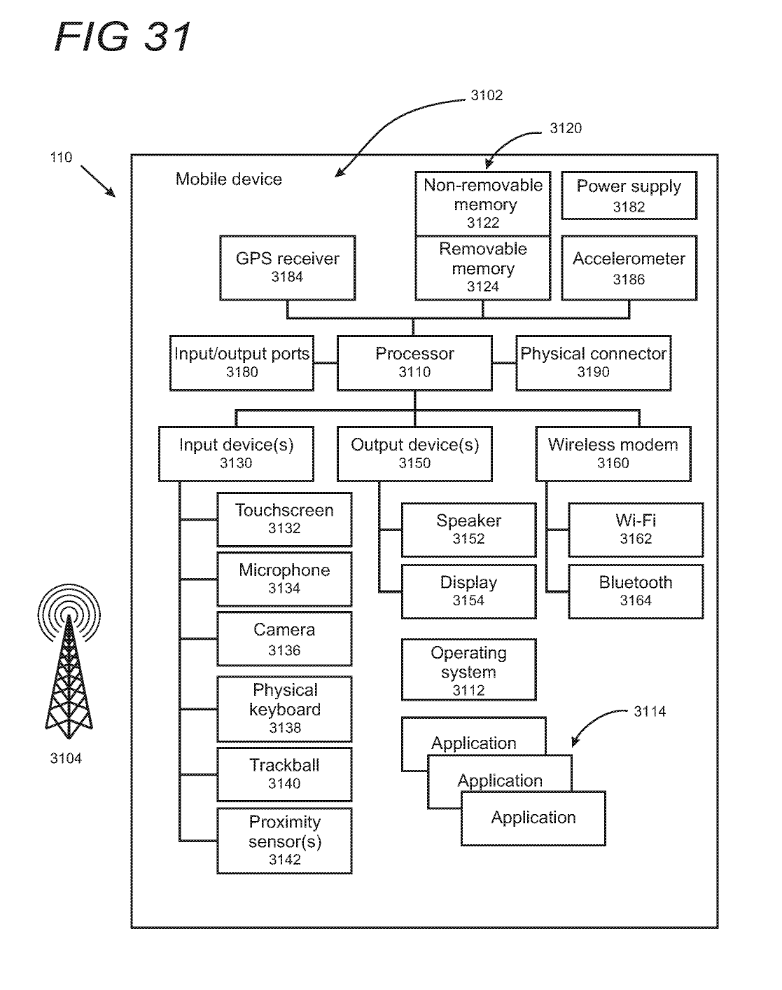

FIG. 31 is a functional block diagram of an illustrative device 110 such as a mobile phone or smartphone including a variety of optional hardware and software components, shown generally at 3102. Any component 3102 in the mobile device can communicate with any other component, although, for ease of illustration, not all connections are shown. The mobile device can be any of a variety of computing devices (e.g., cell phone, smartphone, handheld computer, PDA, etc.) and can allow wireless two-way communications with one or more mobile communication networks 3104, such as a cellular or satellite network.

The illustrated device 110 can include a controller or processor 3110 (e.g., signal processor, microprocessor, microcontroller, ASIC (Application Specific Integrated Circuit), or other control and processing logic circuitry) for performing such tasks as signal coding, data processing, input/output processing, power control, and/or other functions. An operating system 3112 can control the allocation and usage of the components 3102, including power states, above-lock states, and below-lock states, and provides support for one or more application programs 3114. The application programs can include common mobile computing applications (e.g., image-capture applications, e-mail applications, calendars, contact managers, web browsers, messaging applications), or any other computing application.

The illustrated device 110 can include memory 3120. Memory 3120 can include non-removable memory 3122 and/or removable memory 3124. The non-removable memory 3122 can include RAM, ROM, Flash memory, a hard disk, or other well-known memory storage technologies. The removable memory 3124 can include Flash memory or a Subscriber Identity Module (SIM) card, which is well known in GSM (Global System for Mobile communications) systems, or other well-known memory storage technologies, such as “smart cards.” The memory 3120 can be used for storing data and/or code for running the operating system 3112 and the application programs 3114. Example data can include web pages, text, images, sound files, video data, or other data sets to be sent to and/or received from one or more network servers or other devices via one or more wired or wireless networks.

The memory 3120 may also be arranged as, or include, one or more computer-readable storage media implemented in any method or technology for storage of information such as computer-readable instructions, data structures, program modules or other data. For example, computer-readable media includes, but is not limited to, RAM, ROM, EPROM, EEPROM, Flash memory or other solid state memory technology, CD-ROM (compact-disc ROM), DVD, (Digital Versatile Disc) HD-DVD (High Definition DVD), Blu-ray, or other optical storage, magnetic cassettes, magnetic tape, magnetic disk storage or other magnetic storage devices, or any other medium which can be used to store the desired information and which can be accessed by the device 110.

The memory 3120 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment. The device 110 can support one or more input devices 3130—such as a touchscreen 3132; microphone 3134 for implementation of voice input for voice recognition, voice commands and the like; camera 3136; physical keyboard 3138; trackball 3140; and/or proximity sensor 3142; and one or more output devices 3150- such as a speaker 3152 and one or more displays 3154. Other input devices (not shown) using gesture recognition may also be utilized in some cases. Other possible output devices (not shown) can include piezoelectric or haptic output devices. Some devices can serve more than one input/output function. For example, touchscreen 3132 and display 3154 can be combined into a single input/output device.

A wireless modem 3160 can be coupled to an antenna (not shown) and can support two-way communications between the processor 3110 and external devices, as is well understood in the art. The modem 3160 is shown generically and can include a cellular modem for communicating with the mobile communication network 3104 and/or other radio-based modems (e.g., Bluetooth® 3164 or Wi-Fi 3162). The wireless modem 3160 is typically configured for communication with one or more cellular networks, such as a GSM network for data and voice communications within a single cellular network, between cellular networks, or between the device and a public switched telephone network (PSTN).

The device can further include at least one input/output port 3180, a power supply 3182, a satellite navigation system receiver 3184, such as a GPS receiver, an accelerometer 3186, a gyroscope (not shown), and/or a physical connector 3190, which can be a USB port, IEEE 1394 (FireWire) port, and/or an RS-232 port. The illustrated components 3102 are not required or all-inclusive, as any components can be deleted and other components can be added.

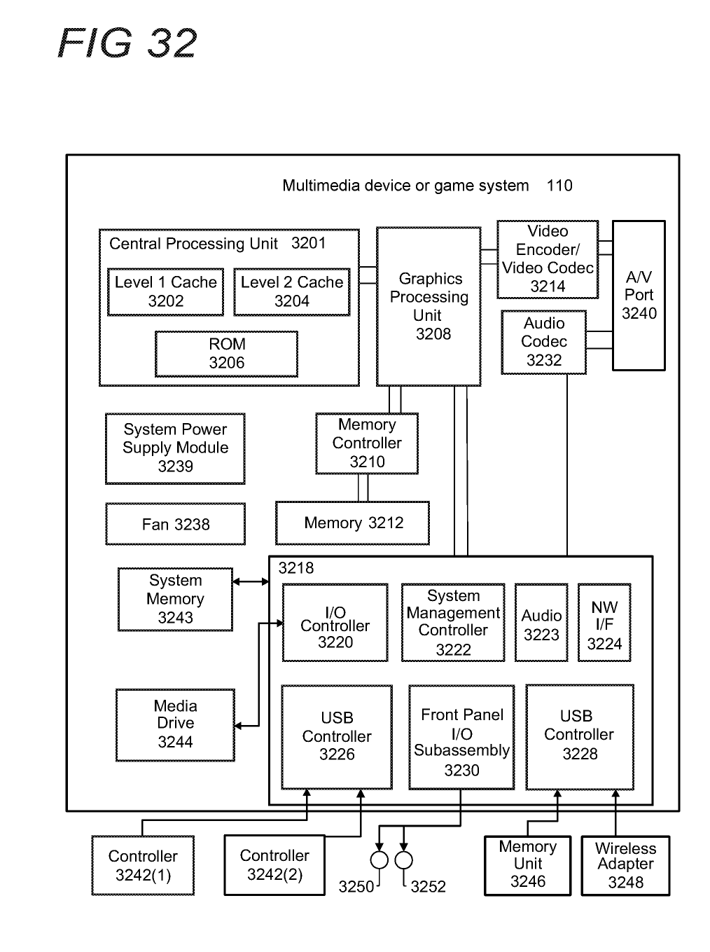

FIG. 32 is an illustrative functional block diagram of a multimedia system or game system which may be embodied as a device 110 (FIG. 1). The multimedia system 110 has a central processing unit (CPU) 3201 having a level 1 cache 3202, a level 2 cache 3204, and a Flash ROM (Read Only Memory) 3206. The level 1 cache 3202 and the level 2 cache 3204 temporarily store data and hence reduce the number of memory access cycles, thereby improving processing speed and throughput. The CPU 3201 may be configured with more than one core, and thus, additional level 1 and level 2 caches 3202 and 3204. The Flash ROM 3206 may store executable code that is loaded during an initial phase of a boot process when the multimedia system 110 is powered ON.

A graphics processing unit (GPU) 3208 and a video encoder/video codec (coder/decoder) 3214 form a video processing pipeline for high speed and high resolution graphics processing. Data is carried from the GPU 3208 to the video encoder/video codec 3214 via a bus. The video processing pipeline outputs data to an A/V (audio/video) port 3240 for transmission to a television or other display. A memory controller 3210 is connected to the GPU 3208 to facilitate processor access to various types of memory 3212, such as, but not limited to, a RAM.

The multimedia system 110 includes an I/O controller 3220, a system management controller 3222, an audio processing unit 3223, a network interface controller 3224, a first USB (Universal Serial Bus) host controller 3226, a second USB controller 3228, and a front panel I/O subassembly 3230 that are preferably implemented on a module 3218. The USB controllers 3226 and 3228 serve as hosts for peripheral controllers 3242(1) and 3242(2), a wireless adapter 3248, and an external memory device 3246 (e.g., Flash memory, external CD/DVD ROM drive, removable media, etc.). The network interface controller 3224 and/or wireless adapter 3248 provide access to a network (e.g., the Internet, home network, etc.) and may be any of a wide variety of various wired or wireless adapter components including an Ethernet card, a modem, a Bluetooth® module, a cable modem, or the like.

System memory 3243 is provided to store application data that is loaded during the boot process. A media drive 3244 is provided and may comprise a DVD/CD drive, hard drive, or other removable media drive, etc. The media drive 3244 may be internal or external to the multimedia system 110. Application data may be accessed via the media drive 3244 for execution, playback, etc. by the multimedia system 110. The media drive 3244 is connected to the I/O controller 3220 via a bus, such as a Serial ATA bus or other high speed connection (e.g., IEEE 1394).

The system management controller 3222 provides a variety of service functions related to assuring availability of the multimedia system 110. The audio processing unit 3223 and an audio codec 3232 form a corresponding audio processing pipeline with high fidelity and stereo processing. Audio data is carried between the audio processing unit 3223 and the audio codec 3232 via a communication link. The audio processing pipeline outputs data to the A/V port 3240 for reproduction by an external audio player or device having audio capabilities.

The front panel I/O subassembly 3230 supports the functionality of the power button 3250 and the eject button 3252, as well as any LEDs (light emitting diodes) or other indicators exposed on the outer surface of the multimedia system 110. A system power supply module 3239 provides power to the components of the multimedia system 110. A fan 3238 cools the circuitry within the multimedia system 110.

The CPU 3201, GPU 3208, memory controller 3210, and various other components within the multimedia system 110 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia system 110 is powered ON, application data may be loaded from the system memory 3243 into memory 3212 and/or caches 3202 and 3204 and executed on the CPU 3201. The application may present a graphical user interface that provides a consistent user experience when navigating to different media types available on the multimedia system 110. In operation, applications and/or other media contained within the media drive 3244 may be launched or played from the media drive 3244 to provide additional functionalities to the multimedia system 110.

The multimedia system 110 may be operated as a standalone system by simply connecting the system to a television or other display. In this standalone mode, the multimedia system 110 allows one or more users to interact with the system, watch movies, or listen to music. However, with the integration of broadband connectivity made available through the network interface controller 3224 or the wireless adapter 3248, the multimedia system 110 may further be operated as a participant in a larger network community.

When the multimedia system 110 is powered ON, a set amount of hardware resources are reserved for system use by the multimedia system operating system. These resources may include a reservation of memory (e.g., 16 MB), CPU and GPU cycles (e.g., 5%), networking bandwidth (e.g., 8 kbps), etc. Because these resources are reserved at system boot time, the reserved resources do not exist from the application's view.

In particular, the memory reservation preferably is large enough to contain the launch kernel, concurrent system applications, and drivers. The CPU reservation is preferably constant such that if the reserved CPU usage is not used by the system applications, an idle thread will consume any unused cycles.

With regard to the GPU reservation, lightweight messages generated by the system applications (e.g., pop-ups) are displayed by using a GPU interrupt to schedule code to render pop-ups into an overlay. The amount of memory needed for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV re-sync is eliminated.

After the multimedia system 110 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 3201 at predetermined times and intervals in order to provide a consistent system resource view to the application. The scheduling is to minimize cache disruption for the gaming application running on the multimedia system.

When a concurrent system application requires audio, audio processing is scheduled asynchronously to the gaming application due to time sensitivity. A multimedia system application manager (described below) controls the gaming application audio level (e.g., mute, attenuate) when system applications are active.

Input devices (e.g., controllers 3242(1) and 3242(2)) are shared by gaming applications and system applications. The input devices are not reserved resources, but are to be switched between system applications and the gaming application such that each will have a focus of the device. The application manager preferably controls the switching of input stream, without knowledge of the gaming application's knowledge and a driver maintains state information regarding focus switches.

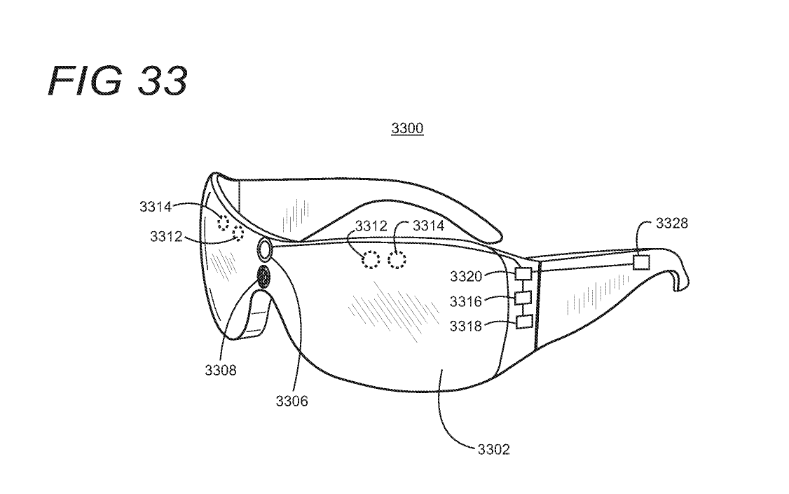

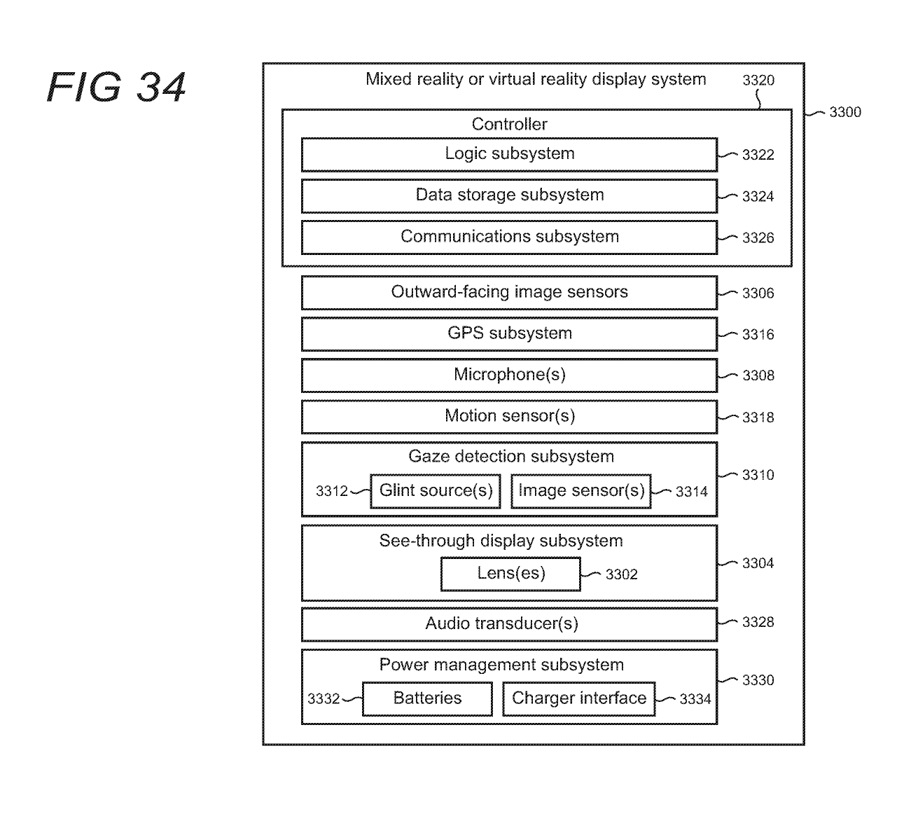

FIG. 33 shows one particular illustrative example of a wearable augmented reality or virtual reality display system 3300, and FIG. 34 shows a functional block diagram of the system 3300. Display system 3300 comprises one or more lenses 3302 that form a part of a see-through display subsystem 3304, such that images may be displayed using lenses 3302 (e.g. using projection onto lenses 3302, one or more waveguide systems incorporated into the lenses 3302, and/or in any other suitable manner). Display system 3300 further comprises one or more outward-facing image sensors 3306 configured to acquire images of a background scene and/or physical environment being viewed by a user, and may include one or more microphones 3308 configured to detect sounds, such as voice commands from a user. Outward-facing image sensors 3306 may include one or more depth sensors and/or one or more two-dimensional image sensors. In alternative arrangements, as noted above, an augmented reality or virtual reality display system, instead of incorporating a see-through display subsystem, may display augmented reality or virtual reality images through a viewfinder mode for an outward-facing image sensor.

The display system 3300 may further include a gaze detection subsystem 3310 configured for detecting a direction of gaze of each eye of a user or a direction or location of focus, as described above. Gaze detection subsystem 3310 may be configured to determine gaze directions of each of a user's eyes in any suitable manner. For example, in the illustrative example shown, a gaze detection subsystem 3310 includes one or more glint sources 3312, such as infrared light sources, that are configured to cause a glint of light to reflect from each eyeball of a user, and one or more image sensors 3314, such as inward-facing sensors, that are configured to capture an image of each eyeball of the user. Changes in the glints from the user's eyeballs and/or a location of a user's pupil, as determined from image data gathered using the image sensor(s) 3314, may be used to determine a direction of gaze.

In addition, a location at which gaze lines projected from the user's eyes intersect the external display may be used to determine an object at which the user is gazing (e.g. a displayed virtual object and/or real background object). Gaze detection subsystem 3310 may have any suitable number and arrangement of light sources and image sensors. In some implementations, the gaze detection subsystem 3310 may be omitted.

The display system 3300 may also include additional sensors. For example, display system 3300 may comprise a global positioning system (GPS) subsystem 3316 to allow a location of the display system 3300 to be determined. This may help to identify real-world objects, such as buildings, etc. that may be located in the user's adjoining physical environment.

The display system 3300 may further include one or more motion sensors 3318 (e.g., inertial, multi-axis gyroscopic, or acceleration sensors) to detect movement and position/orientation/pose of a user's head when the user is wearing the system as part of an augmented reality or virtual reality HMD device. Motion data may be used, potentially along with eye-tracking glint data and outward-facing image data, for gaze detection, as well as for image stabilization to help correct for blur in images from the outward-facing image sensor(s) 3306. The use of motion data may allow changes in gaze direction to be tracked even if image data from outward-facing image sensor(s) 3306 cannot be resolved.

In addition, motion sensors 3318, as well as microphone(s) 3308 and gaze detection subsystem 3310, also may be employed as user input devices, such that a user may interact with the display system 3300 via gestures of the eye, neck and/or head, as well as via verbal commands in some cases. It may be understood that sensors illustrated in FIGS. 33 and 34 and described in the accompanying text are included for the purpose of example and are not intended to be limiting in any manner, as any other suitable sensors and/or combination of sensors may be utilized to meet the needs of a particular implementation. For example, biometric sensors (e.g., for detecting heart and respiration rates, blood pressure, brain activity, body temperature, etc.) or environmental sensors (e.g., for detecting temperature, humidity, elevation, UV (ultraviolet) light levels, etc.) may be utilized in some implementations.

The display system 3300 can further include a controller 3320 having a logic subsystem 3322 and a data storage subsystem 3324 in communication with the sensors, gaze detection subsystem 3310, display subsystem 3304, and/or other components through a communications subsystem 3326. The communications subsystem 3326 can also facilitate the display system being operated in conjunction with remotely located resources, such as processing, storage, power, data, and services. That is, in some implementations, an HIVID device can be operated as part of a system that can distribute resources and capabilities among different components and subsystems.

The storage subsystem 3324 may include instructions stored thereon that are executable by logic subsystem 3322, for example, to receive and interpret inputs from the sensors, to identify location and movements of a user, to identify real objects using surface reconstruction and other techniques, and dim/fade the display based on distance to objects so as to enable the objects to be seen by the user, among other tasks.

The display system 3300 is configured with one or more audio transducers 3328 (e.g., speakers, earphones, etc.) so that audio can be utilized as part of an augmented reality or virtual reality experience. A power management subsystem 3330 may include one or more batteries 3332 and/or protection circuit modules (PCMs) and an associated charger interface 3334 and/or remote power interface for supplying power to components in the display system 3300.

It may be appreciated that the display system 3300 is described for the purpose of example, and thus is not meant to be limiting. It may be further understood that the display device may include additional and/or alternative sensors, cameras, microphones, input devices, output devices, etc. than those shown without departing from the scope of the present arrangement. Additionally, the physical configuration of a display device and its various sensors and subcomponents may take a variety of different forms without departing from the scope of the present arrangement.

Various exemplary embodiments of the present varying modality of user experiences with a mobile device based on context are now presented by way of illustration and not as an exhaustive list of all embodiments. An example includes one or more hardware-based computer-readable memory devices storing instructions which, when executed by one or more processors disposed in a computing device, cause the computing device to: render a classic region on a display, the classic region being populated with icons in a graphical user interface (GUI); and monitor a digital assistant that interacts with a user, wherein the digital assistant is configured to: periodically collect context data associated with the user or the computing device, and wherein the context data is at least partially collected from the interactions between the digital assistant and the user, identify a modality based on the monitored context data, wherein the modality includes a configuration of the GUI that is different from the classic region, pre-load the modality, and render an active region using the pre-loaded modality on the display.

In another example, the classic region is displayed while the modality is pre-loaded. In another example, the context data includes one or more of sensor data, calendar data, contact data, communication data, location data, user interaction with the digital assistant, user feedback, or third-party feedback. In another example, the user interaction with the digital assistant includes one or more of gathering information, answering questions for the user, performing tasks, providing reminders to the user, or searching files. In another example, the digital assistant is further configured to: create an icon based on the user interactions with the digital assistant; and populate the active region with the created icon. In another example, the created icon is website accessible over the Internet. In another example, the digital assistant is further configured to: when a current modality of the active region is rendered, identify a new modality based on the collected context data, wherein the new modality includes a configuration of the GUI that is different from both the active region and the classic region; remove the current modality from the active region of the display; and render the display with the new modality. In another example, the new modality is defined by one or more changes of type, position, size, color, or animation of icons.

A further example includes a method to dynamically update graphical user interface (GUI) configurations of an electronic device, comprising: storing a plurality of modalities associated with a user of the electronic device, wherein each of the plurality of modalities is mapped to a respective contextual scenario associated with the user, and wherein each modality defines a unique combination of GUI elements; upon an occurrence of a contextual scenario, transmitting a communication to the electronic device to responsively select a corresponding mapped modality with which to configure the GUI; receiving user input indicating feedback for at least a portion of the selected modality; identifying non-selected modalities of the plurality of modalities to which the feedback applies; and modifying the identified non-selected modalities using the feedback.

In another example, the feedback comprises user adjustment of one or more of a size, shape, position, color, animation, or description of a GUI element. In another example, the method further comprises: searching for non-selected modalities associated with an unrelated user; and applying the feedback to the non-selected modalities of the unrelated user. In another example, the user is in a group of users, each member of the group being associated with respective one or more unique devices, and the method further comprising: receiving user input from the group of users describing feedback for the selected modality; identifying a pattern in the feedback; and when a pattern is identified, providing the feedback to devices associated with one or more users that are not in the group. In another example, the identified pattern is provided to the devices when a number of users meeting a predetermined threshold have submitted feedback.

A further example includes a mobile computing device configured for utilization by a user, comprising: one or more processors; a display device supporting a graphical user interface (GUI); and one or more hardware-based memory devices storing a plurality of applications and further storing computer-readable instructions which, when executed by the one or more processors cause the mobile computing device to: identify categories for icons based on applications with which respective icons are associated; configure the GUI rendered on the display device into a context-based region and a non-context-based region; develop contextual data using responsive interactions of the digital assistant with the user; determine a subset of icons based on the developed contextual data, wherein the subset includes icons from different categories; present the subset of icons in the context-based region of the display device; and hold remaining icons not in the subset in the non-context-based region of the display device in a configuration that remains static as the contextual data is developed.

In another example, the categories include one or more of fitness, news, entertainment, finance, food, business, travel, sports, photo and video, shopping, or weather. In another example, the developed contextual data is based on the user interacting with the digital assistant using voice, gestures, or physical interaction. In another example, the executed instructions further cause the mobile computing device to iteratively change presentation of the subset of icons according to changes in the developed contextual data, in which each change of presentation of the subset of icons comprises a new modality. In another example, the changes in presentation include a change of icons in the subset or one or more icons within the subset changing in one or more of size, color, position, orientation, or animation. In another example, the executed instructions further cause the mobile computing device to add an icon into the context-based region upon an occurrence of an event, wherein the event is unrelated to the contextual data. In another example, the event is one or more of receiving a message or receiving a notification associated with an application.

The subject matter described above is provided by way of illustration only and is not to be construed as limiting. Various modifications and changes may be made to the subject matter described herein without following the example embodiments and applications illustrated and described, and without departing from the true spirit and scope of the present invention, which is set forth in the following claims.

What is claimed:

1. One or more hardware-based computer-readable memory devices storing instructions which, when executed by one or more processors disposed in a computing device, cause the computing device to:
render a classic region on a display, the classic region being populated with icons in a graphical user interface (GUI); and
monitor a digital assistant that interacts with a user, wherein the digital assistant is configured to:
periodically collect context data associated with the user or the computing device, and wherein the context data is at least partially collected from the interactions between the digital assistant and the user,
identify a modality based on the monitored context data, wherein the modality includes a configuration of the GUI that is different from the classic region,
pre-load the modality, and
render an active region using the pre-loaded modality on the display.

2. The one or more hardware-based computer-readable memory devices of claim 1, wherein the classic region is displayed while the modality is pre-loaded.

3. The one or more hardware-based computer-readable memory devices of claim 1, wherein the context data includes one or more of sensor data, calendar data, contact data, communication data, location data, user interaction with the digital assistant, user feedback, or third-party feedback.

4. The one or more hardware-based computer-readable memory devices of claim 3, wherein the user interaction with the digital assistant includes one or more of gathering information, answering questions for the user, performing tasks, providing reminders to the user, or searching files.

5. The one or more hardware-based computer-readable memory devices of claim 1, wherein the digital assistant is further configured to:
create an icon based on the user interactions with the digital assistant; and
populate the active region with the created icon.

6. The one or more hardware-based computer-readable memory devices of claim 5, wherein the created icon is website accessible over the Internet.

7. The one or more hardware-based computer-readable memory devices of claim 1, wherein the digital assistant is further configured to:
when a current modality of the active region is rendered, identify a new modality based on the collected context data, wherein the new modality includes a configuration of the GUI that is different from both the active region and the classic region;
remove the current modality from the active region of the display; and
render the display with the new modality.

8. The one or more hardware-based computer-readable memory devices of claim 7, wherein the new modality is defined by one or more changes of type, position, size, color, or animation of icons.

9. A method to dynamically update graphical user interface (GUI) configurations of an electronic device, comprising:
storing a plurality of modalities associated with a user of the electronic device, wherein each of the plurality of modalities is mapped to a respective contextual scenario associated with the user, and wherein each modality defines a unique combination of GUI elements;
upon an occurrence of a contextual scenario, transmitting a communication to the electronic device to responsively select a corresponding mapped modality with which to configure the GUI;
receiving user input indicating feedback for at least a portion of the selected modality;
identifying non-selected modalities of the plurality of modalities to which the feedback applies; and
modifying the identified non-selected modalities using the feedback.

10. The method of claim 9, wherein the feedback comprises user adjustment of one or more of a size, shape, position, color, animation, or description of a GUI element.

11. The method of claim 9, further comprising:
searching for non-selected modalities associated with an unrelated user; and
applying the feedback to the non-selected modalities of the unrelated user.

12. The method of claim 9, wherein the user is in a group of users, each member of the group being associated with respective one or more unique devices, and the method further comprising:
receiving user input from the group of users describing feedback for the selected modality;
identifying a pattern in the feedback; and
when a pattern is identified, providing the feedback to devices associated with one or more users that are not in the group.

13. The method of claim 12, wherein the identified pattern is provided to the devices when a number of users meeting a predetermined threshold have submitted feedback.

14. A mobile computing device configured for utilization by a user, comprising:
one or more processors;
a display device supporting a graphical user interface (GUI); and
one or more hardware-based memory devices storing a plurality of applications and further storing computer-readable instructions which, when executed by the one or more processors cause the mobile computing device to:
identify categories for icons based on applications with which respective icons are associated;
configure the GUI rendered on the display device into a context-based region and a non-context-based region;
develop contextual data using responsive interactions of the digital assistant with the user;
determine a subset of icons based on the developed contextual data, wherein the subset includes icons from different categories;
present the subset of icons in the context-based region of the display device; and
hold remaining icons not in the subset in the non-context-based region of the display device in a configuration that remains static as the contextual data is developed.

15. The mobile computing device of claim 14, wherein the categories include one or more of fitness, news, entertainment, finance, food, business, travel, sports, photo and video, shopping, or weather.

16. The mobile computing device of claim 14, wherein the developed contextual data is based on the user interacting with the digital assistant using voice, gestures, or physical interaction.

17. The mobile computing device of claim 14, in which the executed instructions further cause the mobile computing device to iteratively change presentation of the subset of icons according to changes in the developed contextual data, in which each change of presentation of the subset of icons comprises a new modality.

18. The mobile computing device of claim 17, wherein the changes in presentation include a change of icons in the subset or one or more icons within the subset changing in one or more of size, color, position, orientation, or animation.

19. The mobile computing device of claim 14, in which the executed instructions further cause the mobile computing device to add an icon into the context-based region upon an occurrence of an event, wherein the event is unrelated to the contextual data.

20. The mobile computing device of claim 19, wherein the event is one or more of receiving a message or receiving a notification associated with an application.
